(19) United States
(12) Patent Application Publication
(10) Pub. No.: US 2025/0026370 A1
(43) Pub. Date: Jan. 23, 2025

(54) METHOD AND A SYSTEM OF DETERMINING A TRAJECTORY FOR AN AUTONOMOUS VEHICLE

(71) Applicant: Direct Cursus Technology L.L.C, Dubai (AE)

(72) Inventors: Maksim PONOMAREV, Yekaterinburg (RU); Vsevolod ORLOV, Zhukovskiy (RU)

(21) Appl. No.: 18/774,353

(22) Filed: Jul. 16, 2024

(30) Foreign Application Priority Data
Jul. 21, 2023 (RU) 2023119351

(51) Int. Cl. B60W 60/00; B60W 50/00; G06N 3/04

(52) U.S. Cl. CPC B60W 60/001; B60W 50/0097; G06N 3/04; B60W 2554/4041; B60W 2556/25

(57) ABSTRACT

A method and a system for planning motion of a Self-Driving Car (SDC) are provided. The method comprises: receiving sensed data representative of the surroundings of the SDC; feeding the sensed data to a plurality of machine-learning (ML) models, the feeding comprising: feeding the sensed data to a first ML model to generate a first prediction for a given object in the surroundings of the SDC; in response to a time for generating the first prediction being higher than a predetermined threshold: planning the motion of the SDC based on the first prediction; and in response to the time for generating the first prediction being lower than the first predetermined time period threshold: feeding the first prediction along with the sensed data to a second ML model to generate a second prediction for the given object; and planning the motion of the SDC based on the second prediction.

### CROSS-REFERENCE

The present application claims priority to Russian Patent Application No. 2023119351, entitled “Method and a System of Determining a Trajectory For an Autonomous Vehicle”, filed Jul. 21, 2023, the entirety of which is incorporated herein by reference.

### FIELD

The present technology relates generally to navigating Self-Driving Cars (SDC); and in particular, to a method and a system for determining trajectory for an SDC.

### BACKGROUND

Fully or highly automated driving systems may be designed to operate a vehicle on the road without driver interaction (e.g., driverless mode) or other external control. For instance, self-driving vehicles and/or autonomous vehicles are designed to operate a vehicle in a computer-assisted manner.

An autonomous vehicle (such as but not limited to a Self-Driving Car (SDC, for short), a delivery robot, a warehouse robot, and the like) is configured to traverse a planned path between its current position and a target future position without (or with minimal) input from the driver. To that end, the SDC may have access to a plurality of sensors to “perceive” its surrounding area. For example, a given implementation of the SDC can include one or more cameras, one or more LIDARs, and one or more radars. The SDC may further have access to a 3D map to localize itself in the space.

One of the technical challenges associated with the SDC's is their ability to predict, or otherwise determine trajectories of other road users (other vehicles, for example) travelling in the surrounding area of the SDC, for example, in neighbouring lanes. When a given vehicle, travelling, for example, ahead of the SDC in a neighbouring lane, is about to perform a maneuver (such as turning left or right), its trajectory may overlap and/or intersect (at least partially) with the trajectory of the SDC, which may cause high risk of collision between the SDC and one of the other vehicles (including the given one) in the surrounding area. Consequently, this may require the SDC to take corrective measures, be it braking or otherwise active accelerating resulting in building the SDC trajectory ensuring minimal risk of an accident.

Typically, the SDC can be configured to determine the trajectory based on objects located in the current surroundings of the SDC. To that end, for example, the processor of the SDC can be configured to: (i) receive sensed data (such as LIDAR data) of the surroundings of the SDC; and (ii) using an object detection machine-learning algorithm, based on the sensed data, determine locations and object classes (such as vehicle, a passenger, a streetlamp, and the like) of the objects in the surroundings of the SDC. Further, based on the so detected objects in the surroundings of the SDC and/or their object classes, the processor can be configured to generate the trajectory of the SDC. For example, the processor can be configured to generate the trajectory such that the SDC would avoid a collision with the surrounding objects thereof.

The object class can include object-specific features. For example, the object-specific features for a given vehicle can include, without limitation: a type of the object, such as a mobile object, a type of the mobile object, such as a vehicle, a brand of the vehicle, a body type of the vehicle, a year of production of the vehicle, overall dimensions of the vehicle, and the like.

However, determining all of the object-specific features for the each of the objects in the SDC's surroundings every time when the processor needs to generate a new trajectory for the SDC (such as a maneuver, for example) may be a very computationally extensive task for the processor.

Certain prior art approaches have been proposed to tackle the above-identified technical problem.

U.S. Pat. No. 11,215,999-B2, issued on Jan. 4, 2022, assigned to Tesla Inc, and entitled “DATA PIPELINE AND DEEP LEARNING SYSTEM FOR AUTONOMOUS DRIVING,” discloses receiving an image captured using a sensor on a vehicle and further decomposing into a plurality of component images. Each component image of the plurality of component images is provided as a different input to a different layer of a plurality of layers of an artificial neural network to determine a result. The result of the artificial neural network is used to at least in part autonomously operate the vehicle.

US Patent Application Publication No.: 2022/044,114-A1, published on Feb. 10, 2022, assigned to Nvidia Corp, and entitled “HYBRID QUANTIZATION OF NEURAL NETWORKS FOR EDGE COMPUTING APPLICATIONS,” discloses apparatuses, systems, and techniques to use low precision quantization to train a neural network. In at least one embodiment, one or more weights of a trained model are represented by low bit integer numbers instead of using full floating point precision. Changing precision of the one or more weights is performed by first quantizing all weights and activations of a neural network except for layers that require finer granularity in representation than an 8 bit quantization can provide to generate a first trained model. Subsequently, precision of the one or more weights of the first trained model is changed again to generate a second trained model. For the second trained model, the precision of one or more weights of at least one additional layer is changed in addition to the layers that previously had precision values changed while training the neural network to generate the first trained model.

US Patent Application Publication No.: 2022/188,608-A1, published on Jun. 16, 2022, assigned to Nvidia Corp, and entitled “TECHNIQUES FOR OPTIMIZING NEURAL NETWORKS,” discloses apparatuses, systems, and techniques to cache and reuse data for a neural network. In at least one embodiment, data generated by one or more layers of a neural network is cached and reused by the neural network.

US Patent Application Publication No.: 2022/180,178-A1, published on Jun. 9, 2022, assigned to Nvidia Corp, and entitled “NEURAL NETWORK SCHEDULER,” discloses apparatuses, systems, and techniques to allocate computing resources to perform inferences. In at least one embodiment, one or more neural networks cause computing resources to be identified based, at least in part, on performance requirements of one or more neural networks to perform inferences.

US Patent Application Publication No.: 2022/058,466-A1, published on Feb. 24, 2022, assigned to Nvidia Corp, and entitled “OPTIMIZED NEURAL NETWORK GENERATION,” discloses apparatuses, systems, and techniques to generate an optimized neural network architecture. In at least one embodiment, various neural network components are used to generate one or more neural network configurations, and each neural network configuration is trained in order to determine an optimal neural network architecture for a training dataset.

### SUMMARY

Therefore, there is a need for systems and methods which avoid, reduce, or overcome the limitations of the prior art.

Developers of the present technology have realized that the accuracy of the object detection can be optimized based on the current availability of the computational resources of the processor. More specifically, the developers have devised an object detection pipeline comprising a plurality of machine-learning (ML) models, a given ML model of which is configured to detect the objects in the surroundings of the SDC with a lower accuracy than any sequentially following ML model. More specifically, the given ML model is configured to determine fewer object-specific features of the given object in the surroundings of the SDC than the sequentially following ML model.

Thus, when generating the trajectory for the SDC, the processor can first feed the sensed data indicative of the surroundings to a first ML model of the plurality of ML models, thereby causing the first model to generate a first (rough) prediction for the given object. Further, based on time spent by the first ML model to generate the first prediction, which is indicative of the current availability of the computational resources, the processor can be configured either to (i) cause a second ML model, following the first one, to generate a second, more accurate, prediction for the given object; or (ii) proceed to generating the trajectory based on the first prediction.

Thus, by doing so, certain non-limiting embodiments of the present technology can may allow increasing the efficiency and accuracy of motion planning of the SDC in the conditions of limited computational resources.

More specifically, in accordance with one broad aspect of the present technology, there is provided a computer-implemented method for planning motion of a Self-Driving Car (SDC). The SDC has a plurality of sensors configured to generate sensed data representative of surroundings of the SDC. The SDC is communicatively coupled to a processor configured to execute a plurality of Machine-Learning (ML) models for detecting objects in the surroundings of the SDC. The plurality of ML models is sequentially connected therebetween, such that an output of a first ML model of the plurality of ML models is used as an input to a second ML model, sequentially following after the first ML model in the plurality of ML models. Each one of the plurality of ML models has been trained to detect the objects in the surroundings of the SDC based on the sensed data representative thereof. A given sequential ML model is configured to detect the objects with a respective value of an object detection precision metric. The respective value of the object detection precision metric associated with the given sequential ML model is higher than any one of those that are associated with ML models of the plurality of ML models preceding the given sequential ML model. The method comprising: receiving the sensed data representative of the surroundings of the SDC; feeding the sensed data to the plurality of the ML models, the feeding comprising: feeding the sensed data to the first ML model, thereby causing the first ML model to generate a first prediction of (i) an object class of at least one object in the surroundings of the SDC and (ii) a location of the at least one object; and in response to a first time for generating the first prediction by the first ML model being higher than a first predetermined time period threshold assigned to the first ML model for generating the first prediction: planning the motion of the SDC based on the first prediction; and in response to the first time for generating the first prediction by the first ML model being equal to or lower than the first predetermined time period threshold: feeding the first prediction along with the sensed data to the second ML model, thereby causing the second ML model to generate a second prediction of (i) the object class of the at least one object in the surroundings of the SDC and (ii) the location of the at least one object; and planning the motion of the SDC based on the second prediction.

In some implementations of the method, the first time for generating the first prediction is indicative of current availability of computational resources of the processor of the SDC.

In some implementations of the method, the method further comprising training each one of the plurality of ML models, by: generating a training set of data comprising a plurality of training digital objects, a given one of which includes: (i) training sensed data representative of training surroundings of the SDC; and (ii) a respective label representative of the object class and location of at least one training object in the training surrounding of the SDC; and
feeding the training data to the plurality of ML models, the feeding comprising: to the first ML model of the plurality of ML models, feeding the training data; to the given sequential ML model following the first ML model, feeding, by the processor: (i) the training data and (ii) a respective training prediction generated by an ML model preceding the given sequential one; and optimizing, for each one of the plurality of ML models, a respective difference between the respective training prediction thereof and the respective label, thereby training each one of the plurality of ML models to detect the objects on the surroundings of the SDC.

In some implementations of the method, the method further comprises in response to the second time for generating the second prediction by the second ML model being equal to or lower than a second predetermined time period threshold assigned to the second ML model for generating the second prediction: feeding the second prediction along with the sensed data to a third ML model of the plurality of ML models, following the second ML model, thereby causing the third ML model to generate a third prediction of (i) the object class of the at least one object in the surroundings of the SDC and (ii) the location of the at least one object; and planning the motion of the SDC based on the third prediction.

In some implementations of the method, the method further comprises in response to a respective time for generating a respective prediction by the given sequential ML model being equal to or lower than a respective predetermined time period threshold assigned to the given ML model for generating the respective prediction: feeding the respective prediction along with the sensed data to a next sequential ML model of the plurality of ML models, following the given sequential ML model, thereby causing the next sequential ML model to generate an other respective prediction of (i) the object class of the at least one object in the surroundings of the SDC and (ii) the location of the at least one object; and planning the motion of the SDC based on the respective prediction generated by the next sequential ML model; and in response to the respective time for generating the respective prediction by the given sequential ML model being higher than the respective predetermined time period threshold assigned to the given ML model for generating the respective prediction: planning the motion of the SDC based on the respective prediction generated by an ML model, immediately preceding the given sequential ML model.

In some implementations of the method, a given value of the object detection precision metric is indicative of a number of features of a given object determined by a respective ML model.

In some implementations of the method, the object detection precision metric is an average precision metric.

In some implementations of the method, a given one of the plurality of ML models is a neural network.

In some implementations of the method, the given sequential model of the plurality of ML models is configured to determine a larger number of features of the at least one object in the surroundings of the SDC than any ML model preceding the given sequential ML model.

In some implementations of the method, the given ML model of the plurality of ML models has more layers than any ML model preceding the given ML model.

In some implementations of the method, the planning the motion of the SDC comprises generating a trajectory for the SDC.

In some implementations of the method, the planning the motion of the SDC comprises determining motion parameters of the SDC, including at least one of: a displacement, a velocity, and an acceleration of the SDC at a given future moment in time.

In accordance with another broad aspect of the present technology, there is provided a system for planning motion a Self-Driving Car (SDC). The SDC has a plurality of sensors configured to generate sensed data representative of surroundings of the SDC. The system comprises at least one processor communicatively coupled to the SDC and configured to execute a plurality of Machine-Learning (ML) models for detecting objects in the surroundings of the SDC. The plurality of ML models being sequentially connected therebetween, such that an output of a first ML model of the plurality of ML models is used as an input to a second ML model, sequentially following after the first ML model in the plurality of ML models. Each one of the plurality of ML models has been trained to detect the objects in the surroundings of the SDC based on the sensed data representative thereof. A given sequential ML model is configured to detect the objects with a respective value of an object detection precision metric. The respective value of the object detection precision metric associated with the given sequential ML model is higher than any one of those that are associated with ML models of the plurality of ML models preceding the given sequential ML model. The system further comprises at least one non-transitory computer-readable memory comprising executable instructions that, when executed by the at least one processor, cause the system to: receive the sensed data representative of the surroundings of the SDC; feed the sensed data to the plurality of the ML models, by: feeding the sensed data to the first ML model, thereby causing the first ML model to generate a first prediction of (i) an object class of at least one object in the surroundings of the SDC and (ii) a location of the at least one object; and in response to a first time for generating the first prediction by the first ML model being higher than a first predetermined time period threshold assigned to the first ML model for generating the first prediction: planning the motion of the SDC based on the first prediction; and in response to the first time for generating the first prediction by the first ML model being equal to or lower than the first predetermined time period threshold: feeding the first prediction along with the sensed data to the second ML model, thereby causing the second ML model to generate a second prediction of (i) the object class of the at least one object in the surroundings of the SDC and (ii) the location of the at least one object; and planning the motion of the SDC based on the second prediction.

In some implementations of the system, the first time for generating the first prediction is indicative of current availability of computational resources of the processor of the SDC.

In some implementations of the system, the at least one processor further causes the system to train each one of the plurality of ML models, by: generating a training set of data comprising a plurality of training digital objects, a given one of which includes: (i) training sensed data representative of training surroundings of the SDC; and (ii) a respective label representative of the object class and location of at least one training object in the training surrounding of the SDC; and feeding the training data to the plurality of ML models, the feeding comprising: to the first ML model of the plurality of ML models, feeding the training data; to the given sequential ML model following the first ML model, feeding, by the processor: (i) the training data and (ii) a respective training prediction generated by an ML model preceding the given sequential one; and optimizing, for each one of the plurality of ML models, a respective difference between the respective training prediction thereof and the respective label, thereby training each one of the plurality of ML models to detect the objects on the surroundings of the SDC.

In some implementations of the system, the at least one processor further causes the system to: in response to the second time for generating the second prediction by the second ML model being equal to or lower than a second predetermined time period threshold assigned to the second ML model for generating the second prediction: feed the second prediction along with the sensed data to a third ML model of the plurality of ML models, following the second ML model, thereby causing the third ML model to generate a third prediction of (i) the object class of the at least one object in the surroundings of the SDC and (ii) the location of the at least one object; and plan the motion of the SDC based on the third prediction.

In some implementations of the system, the at least one processor further causes the system to: in response to a respective time for generating a respective prediction by the given sequential ML model being equal to or lower than a respective predetermined time period threshold assigned to the given ML model for generating the respective prediction: feed the respective prediction along with the sensed data to a next sequential ML model of the plurality of ML models, following the given sequential ML model, thereby causing the next sequential ML model to generate an other respective prediction of (i) the object class of the at least one object in the surroundings of the SDC and (ii) the location of the at least one object; and plan the motion of the SDC based on the respective prediction generated by the next sequential ML model; and in response to the respective time for generating the respective prediction by the given sequential ML model being higher than the respective predetermined time period threshold assigned to the given ML model for generating the respective prediction: plan the motion of the SDC based on the respective prediction generated by an ML model, immediately preceding the given sequential ML model.

In some implementations of the system, a given value of the object detection precision metric is indicative of a number of features of a given object determined by a respective ML model.

In some implementations of the system, the object detection precision metric is an average precision metric.

In some implementations of the system, a given one of the plurality of ML models is a neural network.

In some implementations of the system, the given sequential model of the plurality of ML models is configured to determine a larger number of features of the at least one object in the surroundings of the SDC than any ML model preceding the given sequential ML model.

In some implementations of the system, the given ML model of the plurality of ML models has more layers than any ML model preceding the given ML model.

In the context of the present specification, the term “light source” broadly refers to any device configured to emit radiation such as a radiation signal in the form of a beam, for example, without limitation, a light beam including radiation of one or more respective wavelengths within the electromagnetic spectrum. In one example, the light source can be a “laser source”. Thus, the light source could include a laser such as a solid-state laser, laser diode, a high-power laser, or an alternative light source such as, a light emitting diode (LED)-based light source. Some (non-limiting) examples of the laser source include: a Fabry-Perot laser diode, a quantum well laser, a distributed Bragg reflector (DBR) laser, a distributed feedback (DFB) laser, a fiber-laser, or a vertical-cavity surface-emitting laser (VCSEL). In addition, the laser source may emit light beams in differing formats, such as light pulses, continuous wave (CW), quasi-CW, and so on. In some non-limiting examples, the laser source may include a laser diode configured to emit light at a wavelength between about 650 nm and 1150 nm. Alternatively, the light source may include a laser diode configured to emit light beams at a wavelength between about 800 nm and about 1000 nm, between about 850 nm and about 950 nm, between about 1300 nm and about 1600 nm, or in between any other suitable range. Unless indicated otherwise, the term “about” with regard to a numeric value is defined as a variance of up to 10% with respect to the stated value.

In the context of the present specification, an “output beam” may also be referred to as a radiation beam, such as a light beam, that is generated by the radiation source and is directed downrange towards a region of interest. The output beam may have one or more parameters such as: beam duration, beam angular dispersion, wavelength, instantaneous power, photon density at different distances from light source, average power, beam power intensity, beam width, beam repetition rate, beam sequence, pulse duty cycle, wavelength, or phase etc. The output beam may be unpolarized or randomly polarized, may have no specific or fixed polarization (e.g., the polarization may vary with time), or may have a particular polarization (e.g., linear polarization, elliptical polarization, or circular polarization).

In the context of the present specification, an “input beam” is radiation or light entering the system, generally after having been reflected from one or more objects in the ROI. The “input beam” may also be referred to as a radiation beam or light beam. By reflected is meant that at least a portion of the output beam incident on one or more objects in the ROI, bounces off the one or more objects. The input beam may have one or more parameters such as: time-of-flight (i.e., time from emission until detection), instantaneous power (e.g., power signature), average power across entire return pulse, and photon distribution/signal over return pulse period etc. Depending on the particular usage, some radiation or light collected in the input beam could be from sources other than a reflected output beam. For instance, at least some portion of the input beam could include light-noise from the surrounding environment (including scattered sunlight) or other light sources exterior to the present system.

In the context of the present specification, the term “surroundings” of a given vehicle refers to an area or a volume around the given vehicle including a portion of a current environment thereof accessible for scanning using one or more sensors mounted on the given vehicle, for example, for generating a 3D map of such surroundings or detecting objects therein.

In the context of the present specification, a “Region of Interest” may broadly include a portion of the observable environment of a LiDAR sensor in which the one or more objects may be detected. It is noted that the region of interest of the LiDAR sensor may be affected by various conditions such as but not limited to: an orientation of the LiDAR sensor (e.g. direction of an optical axis of the LiDAR sensor); a position of the LiDAR sensor with respect to the environment (e.g. distance above ground and adjacent topography and obstacles); operational parameters of the LiDAR sensor (e.g. emission power, computational settings, defined angles of operation), etc. The ROI of LiDAR sensor may be defined, for example, by a plane angle or a solid angle. In one example, the ROI may also be defined within a certain distance range (e.g. up to 200 m or so).

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices, however it is not required to be the case with respect to the present technology. Thus, some (non-limiting) examples of electronic devices include self-driving unit, personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices.

In the context of the present specification, the expression “information” includes information of any nature or kind whatsoever capable of being stored in a database. Thus information includes, but is not limited to visual works (e.g. maps), audiovisual works (e.g. images, movies, sound records, presentations etc.), data (e.g. location data, weather data, traffic data, numerical data, etc.), text (e.g. opinions, comments, questions, messages, etc.), documents, spreadsheets, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Further, as is discussed herein in other contexts, reference to a “first” element and a “second” element does not preclude the two elements from being the same actual real-world element.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for implementing certain embodiments of systems and/or methods of the present technology;

FIG. 2 depicts a networked computing environment being suitable for use with some implementations of the present technology;

FIG. 3 depicts a LIDAR data acquisition procedure executed by a processor of an electronic device of the networked computing environment of FIG. 2, the procedure for receiving a 3D point cloud data captured by a LiDAR sensor of a vehicle present in the networked computing environment of FIG. 2, in accordance with certain non-limiting embodiments of the present technology;

FIG. 4 depicts a schematic diagram of the vehicle present in the networked computing environment of FIG. 2 driving within a given road section, the given road section being represented by the 3D point cloud data that has been received by the processor of the networked computing environment of FIG. 2 executing the LIDAR data acquisition procedure of FIG. 3, in accordance with certain non-limiting embodiments of the present technology;

FIG. 5 depicts a schematic diagram of an architecture of a machine-learning algorithm (MLA) used for implementation at least some non-limiting embodiments of the present technology;

FIG. 6 schematically depicts a time diagram of each machine-learning (ML) model of a plurality of ML model of the MLA of FIG. 5 generating a respective prediction for a given surrounding object of the vehicle present in the networked computing environment of FIG. 2, in accordance with certain non-limiting embodiments of the present technology;

FIG. 7 depicts a schematic diagram of a training road section used for generating a given training digital object of a plurality of training digital objects used for training the given ML model of the MLA of FIG. 5 to detect the objects, in accordance with certain non-limiting embodiments of the present technology;

FIGS. 8, 9, and 10 schematically depict different respective predictions for the given surrounding object generated by different ML models of the plurality of ML models of the MLA of FIG. 5, in accordance with certain non-limiting embodiments of the present technology; and

FIG. 11 depicts a flowchart diagram of a computer-implemented method of generating a movement trajectory for the vehicle present in the networked computing environment of FIG. 2 using the MLA of FIG. 5, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

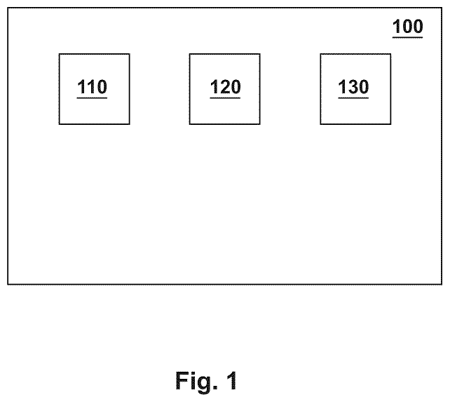

With reference to FIG. 1, there is depicted a schematic diagram of a computer system 100 suitable for use with some implementations of the present technology. The computer system 100 includes various hardware components including one or more single or multi-core processors collectively represented by a processor 110, a solid-state drive 120, and a memory 130, which may be a random-access memory or any other type of memory.

Communication between the various components of the computer system 100 may be enabled by one or more internal and/or external buses (not shown) (e.g. a PCI bus, universal serial bus, IEEE 1394 “Firewire” bus, SCSI bus, Serial-ATA bus, etc.), to which the various hardware components are electronically coupled. According to embodiments of the present technology, the solid-state drive 120 stores program instructions suitable for being loaded into the memory 130 and executed by the processor 110 for determining a presence of an object. For example, the program instructions may be part of a vehicle control application executable by the processor 110. It is noted that the computer system 100 may have additional and/or optional components (not depicted), such as network communication modules, localization modules, and the like.

### Networked Computing Environment

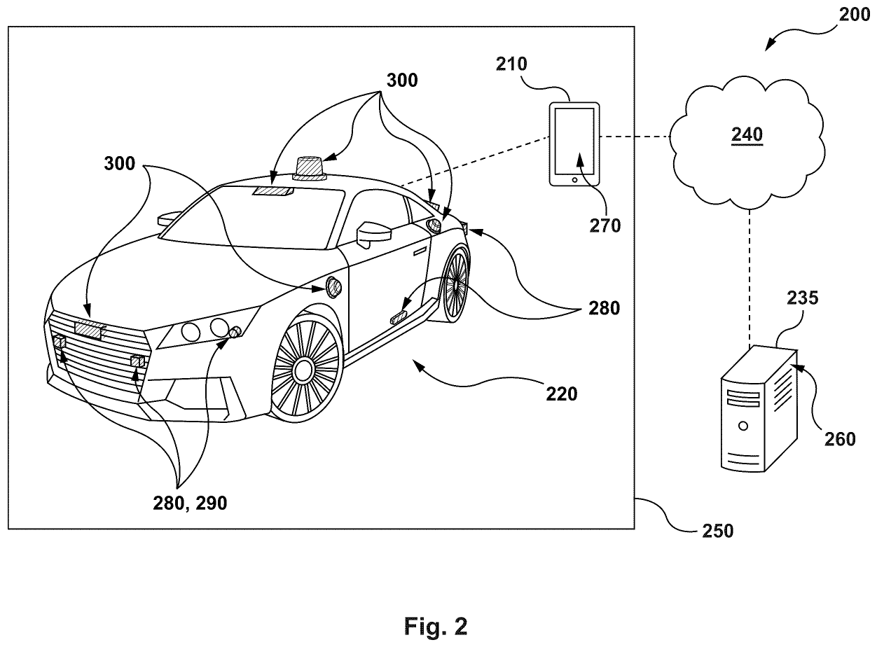

With reference to FIG. 2, there is depicted a networked computing environment 200 suitable for use with some non-limiting embodiments of the present technology. The networked computing environment 200 includes an electronic device 210 associated with a vehicle 220 and/or associated with a user (not depicted) who is associated with the vehicle 220 (such as an operator of the vehicle 220). The environment 200 also includes a server 235 in communication with the electronic device 210 via a communication network 240 (e.g. the Internet or the like, as will be described in greater detail herein below).

In at least some non-limiting embodiments of the present technology, the electronic device 210 is communicatively coupled to control systems of the vehicle 220. The electronic device 210 could be arranged and configured to control different operations systems of the vehicle 220, including but not limited to: an ECU (engine control unit), steering systems, braking systems, and signaling and illumination systems (i.e. headlights, brake lights, and/or turn signals). In such an embodiment, the vehicle 220 could be a self-driving vehicle.

In some non-limiting embodiments of the present technology, the networked computing environment 200 could include a GPS satellite (not depicted) transmitting and/or receiving a GPS signal to/from the electronic device 210. It will be understood that the present technology is not limited to GPS and may employ a positioning technology other than GPS. It should be noted that the GPS satellite can be omitted altogether.

The vehicle 220, to which the electronic device 210 is associated, could be any transportation vehicle, for leisure or otherwise, such as a private or commercial car, truck, motorbike or the like. Although the vehicle 220 is depicted as being a land vehicle, this may not be the case in each and every non-limiting embodiment of the present technology. For example, in certain non-limiting embodiments of the present technology, the vehicle 220 may be a watercraft, such as a boat, or an aircraft, such as a flying drone.

The vehicle 220 may be user-operated or an autonomous (driver-less) vehicle. In some non-limiting embodiments of the present technology, the vehicle 220 could be implemented as a Self-Driving Car (SDC). It should be noted that specific parameters of the vehicle 220 are not limiting, these specific parameters including, for example: vehicle manufacturer, vehicle model, vehicle year of manufacture, vehicle weight, vehicle dimensions, vehicle weight distribution, vehicle surface area, vehicle height, drive train type (e.g., 2× or 4×), tire type, brake system, fuel system, mileage, vehicle identification number, and engine size.

In other non-limiting embodiments of the present technology, the vehicle 220 may be implemented as a delivery robotic vehicle and be used for transporting various items to a user. In this regard, in some non-limiting embodiments of the present technology, the items may comprise items ordered by the user, such as consumer goods, for example, from an online listing platform (such as a Yandex™ Market™ online listing platform, an Avito™ online listing platform, and the like). In this example, the vehicle 220 may be owned by the online listing platform or by another entity associated with the online listing platform. In yet other non-limiting embodiments of the present technology, the vehicle 220 can be implemented as a warehouse robot vehicle and be used for at least one of moving, unloading, loading various inventory items in a warehouse.

According to the present technology, the implementation of the electronic device 210 is not particularly limited. For example, the electronic device 210 could be implemented as a vehicle engine control unit, a vehicle CPU, a vehicle navigation device (e.g. TomTom™, Garmin™), a tablet, a personal computer built into the vehicle 220, and the like. Thus, it should be noted that the electronic device 210 may or may not be permanently associated with the vehicle 220. Additionally or alternatively, the electronic device 210 could be implemented in a wireless communication device such as a mobile telephone (e.g. a smart-phone or a radio-phone). In certain embodiments, the electronic device 210 has a display 270.

The electronic device 210 could include some or all of the components of the computer system 100 depicted in FIG. 1, depending on the particular embodiment. In certain embodiments, the electronic device 210 is an on-board computer device and includes the processor 110, the solid-state drive 120 and the memory 130. In other words, the electronic device 210 includes hardware and/or software and/or firmware, or a combination thereof, for processing data as will be described in greater detail below.

In some non-limiting embodiments of the present technology, the communication network 240 is the Internet. In alternative non-limiting embodiments of the present technology, the communication network 240 can be implemented as any suitable local area network (LAN), wide area network (WAN), a private communication network or the like. It should be expressly understood that implementations for the communication network 240 are for illustration purposes only. A communication link (not separately numbered) is provided between the electronic device 210 and the communication network 240, the implementation of which will depend, inter alia, on how the electronic device 210 is implemented. Merely as an example and not as a limitation, in those non-limiting embodiments of the present technology where the electronic device 210 is implemented as a wireless communication device such as a smartphone or a navigation device, the communication link can be implemented as a wireless communication link. Examples of wireless communication links may include, but are not limited to, a 3G communication network link, a 4G communication network link, and the like. The communication network 240 may also use a wireless connection with the server 235.

In some embodiments of the present technology, the server 235 is implemented as a computer server and could thus include some or all of the components of the computer system 100 of FIG. 1. In one non-limiting example, the server 235 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 235 is a single server. In alternative non-limiting embodiments of the present technology, the functionality of the server 235 may be distributed and may be implemented via multiple servers (not depicted).

In some non-limiting embodiments of the present technology, the processor 110 of the electronic device 210 could be in communication with the server 235 to receive one or more updates. Such updates could include, but are not limited to, software updates, map updates, routes updates, weather updates, and the like. In some non-limiting embodiments of the present technology, the processor 110 can also be configured to transmit to the server 235 certain operational data, such as routes travelled, traffic data, performance data, and the like. Some or all such data transmitted between the vehicle 220 and the server 235 may be encrypted and/or anonymized.

It should be noted that a variety of sensors and systems may be used by the electronic device 210 for gathering information about surroundings 250 of the vehicle 220. As seen in FIG. 2, the vehicle 220 may be equipped with a plurality of sensor systems 280. It should be noted that different sensor systems from the plurality of sensor systems 280 may be used for gathering different types of data regarding the surroundings 250 of the vehicle 220.

In one example, the plurality of sensor systems 280 may include various optical systems including, inter alia, one or more camera-type sensor systems that are mounted to the vehicle 220 and communicatively coupled to the processor 110 of the electronic device 210, such as a camera sensor 290. Broadly speaking, the camera sensor 290 may be configured to gather image data, such as images or a series thereof, about various portions of the surroundings 250 of the vehicle 220.

For example, in specific non-limiting embodiments of the present technology, the camera sensor 290 can be implemented as a mono camera with resolution sufficient to detect surrounding objects at a pre-determined distances of up to about 80 m (although camera systems with other resolutions and ranges are within the scope of the present disclosure) in the surroundings 250 of the vehicle 220. The camera sensor 290 can be mounted on an interior, upper portion of a windshield of the vehicle 220, but other locations are within the scope of the present disclosure, including on a back window, side windows, front hood, rooftop, front grill, or front bumper of the vehicle 220. In some non-limiting embodiments of the present technology, the camera sensor 290 can be mounted in a dedicated enclosure (not depicted) mounted on the top of the vehicle 220.

In some non-limiting embodiments of the present technology, the camera sensor 290 is configured to capture a pre-determine portion of the surroundings 250 around the vehicle 220. In some embodiments of the present technology, the camera sensor 290 is configured to capture the image data that represent approximately 90 degrees of the surroundings 250 around the vehicle 220 that are along a movement path of the vehicle 220.

In other non-limiting embodiments of the present technology, the camera sensor 290 is configured to capture an image (or a series of images) that represent approximately 180 degrees of the surroundings 250 around the vehicle 220 that are along a movement path of the vehicle 220. In yet other non-limiting embodiments of the present technology, the camera sensor 290 is configured to capture the image data that represent approximately 360 degrees of the surroundings 250 around the vehicle 220 that are along a movement path of the vehicle 220 (in other words, the entirety of the surrounding area around the vehicle 220).

In a specific non-limiting example, the camera sensor 290 can be implemented as the camera of a type available from FLIR INTEGRATED IMAGING SOLUTIONS INC., 12051 Riverside Way, Richmond, BC, V6 W 1K7, Canada. It should be expressly understood that the camera sensor 290 can be implemented in any other suitable equipment.

In some cases, the image data provided by the camera sensor 290 could be used by the electronic device 210 for performing object detection procedures, as will be described in detail below.

In another example, the plurality of sensor systems 280 could include one or more radar-type sensor systems (not separately labelled) that are mounted to the vehicle 220 and communicatively coupled to the processor 110 of the electronic device 210. Broadly speaking, the one or more radar-type sensor systems may be configured to make use of radio waves to gather data about various portions of the surroundings 250 of the vehicle 220. For example, the one or more radar-type sensor systems may be configured to gather radar data about potential surrounding objects around the vehicle 220, such data potentially being representative of a distance of surrounding objects from the radar-type sensor system, orientation of surrounding objects, velocity and/or speed of surrounding objects, and the like.

It should be noted that the plurality of sensor systems 280 could include additional types of sensor systems to those non-exhaustively described above and without departing from the scope of the present technology.

For example, according to certain non-limiting embodiments of the present technology and as is illustrated in FIG. 2, the vehicle 220 can be equipped with at least one Light Detection and Ranging (LiDAR) system, such as a LiDAR sensor 300, for gathering information about surroundings 250 of the vehicle 220. While only described herein in the context of being attached to the vehicle 220, it is also contemplated that the LiDAR sensor 300 could be a stand-alone operation or connected to another system.

According to non-limiting embodiments of the present technology, the LiDAR sensor 300 of the vehicle 220 is communicatively coupled to the electronic device 210. In some non-limiting embodiments, information received by the electronic device 210 from the LiDAR sensor 300 could be used, at least in part, in controlling the vehicle 220. For example, in embodiments where the vehicle 220 is a self-driving vehicle, 3D maps created based on information determined by the LiDAR sensor 300 could be used by the electronic device 210 to control, at least in part, the vehicle 220. In another example, the processor 110 of the electronic device 210 can be configured to use the information received by the LiDAR sensor 300 for real-time detection of surrounding objects present in the surroundings 250 of the vehicle 220 for planning motion of the vehicle 220.

In some non-limiting embodiments of the present technology, to plan the motion of the vehicle 220, based on information of the detected surrounding objects, the processor 110 of the electronic device 210 can be configured to generate and/or amend a movement trajectory of the vehicle 220. Also, although most of the examples provided in the description below are detected to the motion planning of the vehicle 220 being generating the movement trajectory thereof, in broader non-limiting embodiments of the present technology, the motion planning of the vehicle 220 can comprise determining, by the processor 110 of the electronic device 210, certain motion parameters of the vehicle 220 at a given future moment in time, such as, at least one of: a displacement, a velocity, and an acceleration of the vehicle 220 at the given future moment in time.

In accordance with certain non-limiting embodiments of the present technology, a given surrounding object can comprise at least one of a moving surrounding object and a stationary surrounding object. For example, a moving surrounding object can include, without limitation, another vehicle, a train, a tram, a cyclist, or a pedestrian. A stationary surrounding object can include, without limitation, a traffic light, a road post, a streetlamp, a curb, a tree, a fire hydrant, a stopped or parked vehicle, and a litter bin, as an example.

It is expected that a person skilled in the art will understand the functionality of the LiDAR sensor 300, but briefly speaking, a light source (such as a laser, not depicted) of the LiDAR sensor 300 is configured to send out light beams that, after having reflected off one or more surrounding objects in the surroundings 250 of the vehicle 220, are scattered back to a receiver (not depicted) of the LiDAR sensor 300. The photons that come back to the receiver are collected with a telescope and counted as a function of time. Using the speed of light (˜3×10⁸ m/s), the processor 110 of the electronic device 210 can then calculate how far the photons have traveled (in the round trip). Photons can be scattered back off of many different entities surrounding the vehicle 220, such as other particles (aerosols or molecules) of water, dust, or smoke in the atmosphere, other vehicles, stationary surrounding objects or potential obstructions in front of the vehicle 220.

Depending on the embodiment, the vehicle 220 could include more or fewer LiDAR sensor 300 than illustrated. Depending on the particular embodiment, choice of inclusion of particular ones of the plurality of sensor systems 280 could depend on the particular embodiment of the LiDAR sensor 300. The LiDAR sensor 300 could be mounted, or retrofitted, to the vehicle 220 in a variety of locations and/or in a variety of configurations.

For example, depending on the implementation of the vehicle 220 and the LiDAR sensor 300, the LiDAR sensor 300 could be mounted on an interior, upper portion of a windshield of the vehicle 220. Nevertheless, as illustrated in FIG. 2, other locations for mounting the LiDAR sensor 300 are within the scope of the present disclosure, including on a back window, side windows, front hood, rooftop, front grill, front bumper or the side of the vehicle 220. In some cases, the LiDAR sensor 300 can even be mounted in a dedicated enclosure mounted on the top of the vehicle 220.

In some non-limiting embodiments of the present technology, such as that of FIG. 2, the LiDAR sensor 300 is mounted to the rooftop of the vehicle 220 in a rotatable configuration. For example, the LiDAR sensor 300 mounted to the vehicle 220 in a rotatable configuration could include at least some components that are rotatable 360 degrees about an axis of rotation of the given LiDAR sensor 300. When mounted in rotatable configurations, the given LiDAR sensor 300 could gather data about most of the portions of the surroundings 250 of the vehicle 220.

In some non-limiting embodiments of the present technology, such as that of FIG. 2, the LiDAR sensor 300 is mounted to the side, or the front grill, for example, in a non-rotatable configuration. For example, the LiDAR sensor 300 mounted to the vehicle 220 in a non-rotatable configuration could include at least some components that are not rotatable 360 degrees and are configured to gather data about pre-determined portions of the surroundings 250 of the vehicle 220.

Irrespective of the specific location and/or the specific configuration of the LiDAR sensor 300, it is configured to capture data about the surroundings 250 of the vehicle 220 used, for example, for building a multi-dimensional map of surrounding objects in the surroundings 250 of the vehicle 220. Details relating to the configuration of the LiDAR sensor 300 to capture the data about the surroundings 250 of the vehicle 220 will now be described.

In a specific non-limiting example, the LiDAR sensor 300 can be implemented as the LiDAR based sensor that may be of the type available from VELODYNE LIDAR, INC. of 5521 Hellyer Avenue, San Jose, CA 95138, United States of America. It should be expressly understood that the LiDAR sensor 300 can be implemented in any other suitable equipment.

It should be noted that although in the description provided herein the LiDAR sensor 300 is implemented as a Time of Flight LiDAR system—and as such, includes respective components suitable for such implementation thereof—other implementations of the LiDAR sensor 300 are also possible without departing from the scope of the present technology. For example, in certain non-limiting embodiments of the present technology, the LiDAR sensor 300 may also be implemented as a Frequency-Modulated Continuous Wave (FMCW) LiDAR system according to one or more implementation variants and based on respective components thereof as disclosed in a co-owned United States Patent Application Publication No.: 2021/373,172-A1 published on Dec. 2, 2021, and entitled “LiDAR DETECTION METHODS AND SYSTEMS”; the content of which is hereby incorporated by reference in its entirety.

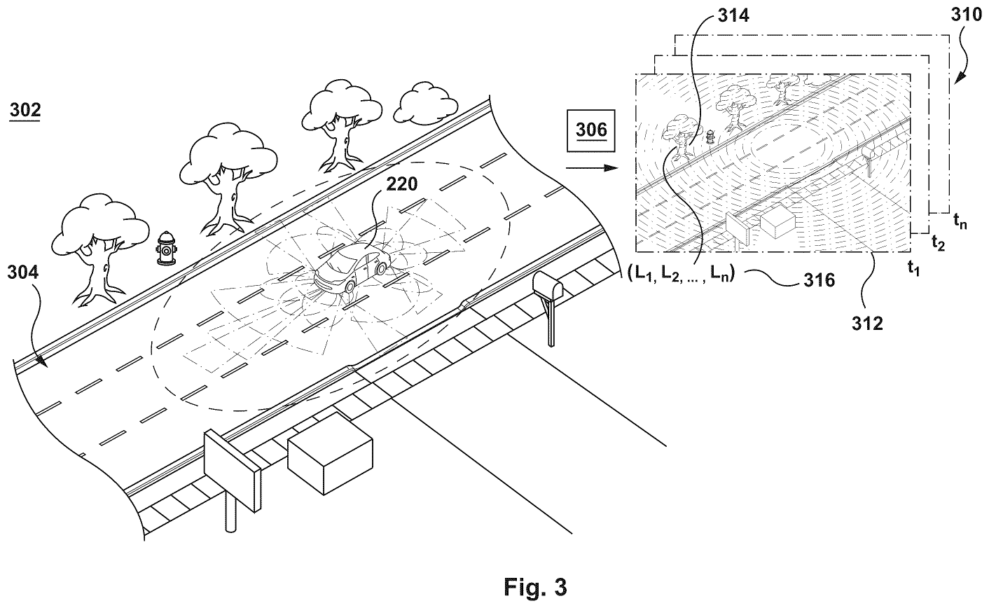

With reference to FIG. 3, there is depicted a schematic diagram of a LiDAR data acquisition procedure 302, executed by the processor 110 of the electronic device 210, for generating a 3D point cloud data 310 representative of surrounding object present in the surroundings 250 of the vehicle 220, in accordance with certain non-limiting embodiments of the present technology.

In some non-limiting embodiments of the present technology, the LiDAR data acquisition procedure 302 of receiving the 3D point cloud data 310 can be executed in a continuous manner. In other embodiments of the present technology, the LiDAR data acquisition procedure 302 of receiving the 3D point cloud data 310 can be implemented at pre-determined intervals, such every 2 milliseconds or any other suitable time interval.

To execute the LiDAR data acquisition procedure 302, as the vehicle 220 travels on a road 304, the processor 110 of the electronic device 210 is configured to acquire, with the LiDAR sensor 300, sensor data 306 representative of the objects in the surrounding area 250 of the vehicle 220. According to certain non-limiting embodiments of the present technology, the processor 110 can be configured to receive the sensor data 306 representative of the objects in the surrounding area 250 of the vehicle 220 at different locations on the road 304 in a form one or more 3D point clouds, such as a 3D point cloud 312.

Generally speaking, the 3D point cloud 312 is a set of LiDAR points in the form of a 3D point cloud, where a given LiDAR point 314 is a point in 3D space indicative of at least a portion of a surface of a given surrounding object on or around the road 304. In some non-limiting embodiments of the present technology, the 3D point cloud 312 may be organized in layers, where points in each layer are also organized in an elliptical fashion and the starting points of all elliptical layers are considered to share a similar orientation.

The given LiDAR point 314 in the 3D point cloud 312 is associated with LiDAR parameters 316 (depicted in FIG. 3 as L1, L2, and Lx). As a non-limiting example, the LiDAR parameters 316 may include: distance, intensity, and angle, as well as other parameters relating to information that may be acquired by the LiDAR sensor 300. The LiDAR sensor 300 may acquire a 3D point cloud at each time step t while the vehicle 220 is travelling, thereby acquiring a set of similar 3D point clouds of the 3D point cloud data 310 about the surroundings 250 of the vehicle 220.

It is contemplated that in some non-limiting embodiments of the present technology, the processor 110 of the electronic device 210 can be configured to enrich the 3D point cloud 312 with the image data obtained from the camera sensor 290. To that end, the processor 110 can be configured to apply one or more approaches described in a co-owned U.S. Pat. No. 11,551,365-B2, published on Jan. 23, 2023, and entitled “METHODS AND SYSTEMS FOR COMPUTER-BASED DETERMINING OF PRESENCE OF OBJECTS”; the content of which is hereby incorporated by reference in its entirety.

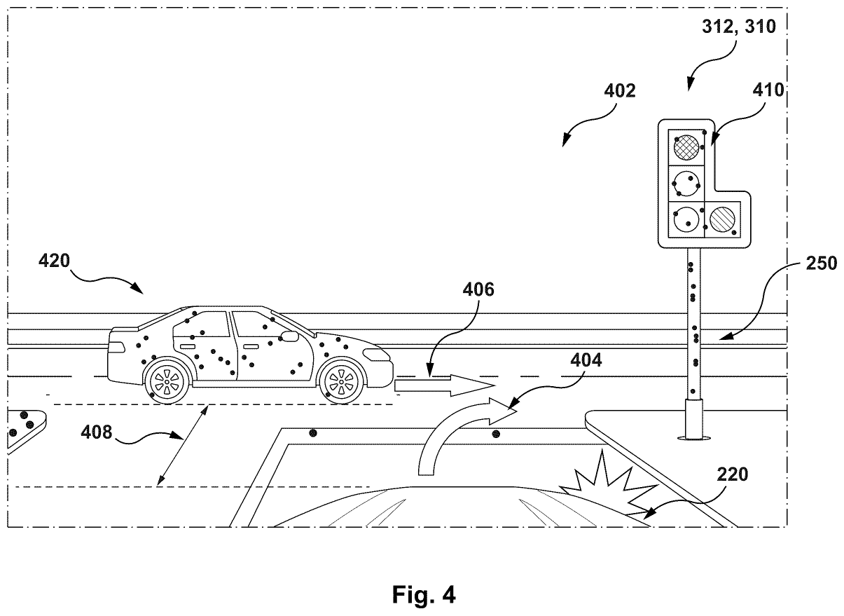

Further, referring back to FIG. 2, using the 3D point cloud 312, the processor 110 can be configured to: (i) detect the objects in the surroundings 250 of the vehicle 220; and (ii) based on the detected objects, determine, for example, the movement trajectory for the vehicle 220. With reference to FIG. 4, there is depicted a schematic diagram of the vehicle 220 driving within a given road section 402, in accordance with certain non-limiting embodiments of the present technology.

As it can be appreciated from FIG. 4, as the vehicle 220 approaches an intersection in the given road section 402, it may be configured, according to a predetermined (prior) movement trajectory thereof, to make a right maneuver 404 to an intersecting road. However, to avoid collision with an upcoming vehicle 420 driving down the intersecting road in a straight direction 406, the vehicle 220 must be capable of (i) detecting the upcoming vehicle 420; and (ii) taking certain corrective measures with respect to the prior predetermined movement trajectory, such as one of slowing down, accelerating, or breaking, as an example, thereby re-determining the movement trajectory for the vehicle 220.

According to certain non-limiting embodiments of the present technology, to detect the upcoming vehicle 420, the processor 110 can be configured to determine: (i) a location of the upcoming vehicle 420 in a coordinate system of the vehicle 220; and (ii) an object class of the upcoming vehicle 420.

In this regard, in some non-limiting embodiments of the present technology, the processor 110 can be configured to use a machine learning algorithm (MLA) 260 hosted by the server 235 configured to detect the objects in the surroundings 250 of the vehicle 220. In the non-limiting embodiments of the present technology, the MLA 260 may be based on neural networks (NN), such as convolutional NN (CNN), Transformer-based NN, and the like, which will be described in greater detail below.

More specifically, for determining the object class of the given surrounding object, the MLA 260 can be configured to determine a plurality of object features describing the given surrounding object. Merely as an example, and in no way as a limitation, in case where the given surrounding object is the upcoming vehicle 420, the object features can include, without limitation: (i) a type of the given surrounding object, such as a movable object; (ii) a type of the movable object, such as an inanimate object; (iii) a type of the movable inanimate object, such as a vehicle; (iv) a brand and a model of the upcoming vehicle 420; (v) an issue year of the upcoming vehicle 420; (vi) a body type of the upcoming vehicle 420, such as a sedan, a hatchback, a wagon vehicle, a minivan and others; (vii) a control type of the upcoming vehicle 420, such as traditional (operated by a driver) or driverless (that is, an other SDC); (viii) a current speed of the upcoming vehicle 420 in the straight direction 406; (ix) a distance 408 from the vehicle 220 to the upcoming vehicle 420; and others.

In another example, where the given surrounding object is a pedestrian (not depicted), the object features can include, without limitation: (i) the type of the object, such as a movable object; (ii) the type of the movable object, such as an animate object; (iii) a type of the movable animate object, such as a human being; (iv) a gender of the human being, such as a woman; (v) a height of the pedestrian; (vi) a weight of the pedestrian; (vii) an age group of the pedestrian, such as an adult or a child; (viii) a current movement direction of the pedestrian; (ix) a current speed of the pedestrian in the current movement direction of the pedestrian; (x) a distance to the pedestrian; and others.

In yet other example, in case where the given surrounding object is a traffic light 410, the object features can include, without limitation: (i) the type of the object, such as a stationary object; (ii) a type of the stationary object, such as a traffic regulation object; (iii) a type of the traffic regulation object, such as a traffic light; (iv) a height of the traffic light 410; (v) a distance to the traffic light 410; and others.

However, the computational resources of the processor 110, for example, due to execution of other tasks, may not be readily available for determining each and every object feature of the given surrounding object for determining the movement trajectory of the vehicle 220. As a result, the determination of the movement trajectory may take the processor 110 and/or the server 235 more time leaving less time for the processor 110 to cause execution of this movement trajectory, which increases risks of a collision between the vehicle 220 and the given surrounding object, such as the upcoming vehicle 420 in the example of FIG. 4.

Thus, the developers of the present technology have developed an architecture for the MLA 260 that includes a plurality of sequentially connected ML models, each of which is configured to generate a respective prediction for the given surrounding object within with a respective object detection precision, which may allow, within an expected timeframe, generating most precise predictions for the given surrounding object given the current availability of the computational resources of the processor 110 and/or server 235.

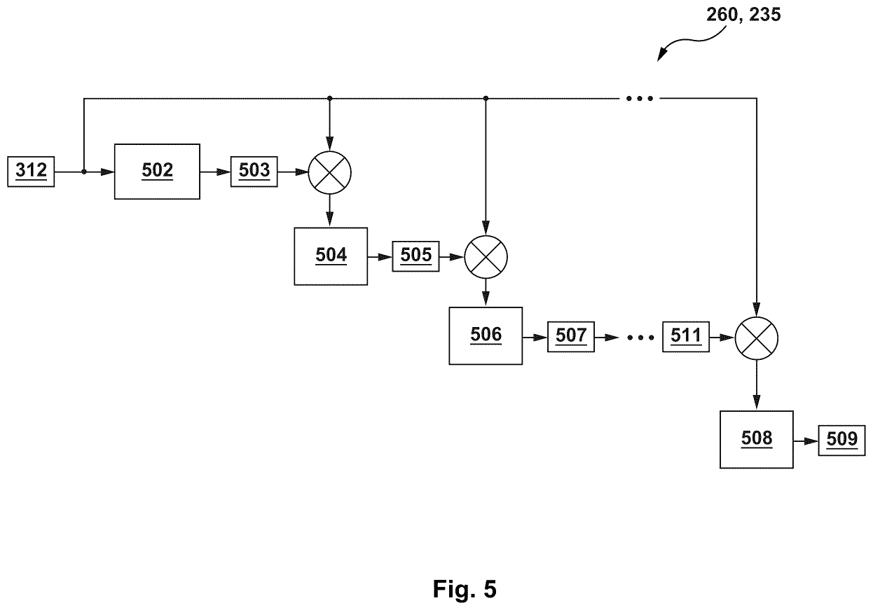

The architecture, the training and in-use processes of the MLA 260 will be described immediately below with references to FIGS. 5 to 11.

### Machine-Learning Algorithm Architecture

With reference to FIG. 5, there is schematically depicted the architecture of the MLA 260, in accordance with certain non-limiting embodiments of the present technology. As it can be appreciated, the architecture of the MLA 260 comprises the plurality of ML models, such as: a first ML model 502, a second ML model 504, a third ML model 506, and a final ML model 508. Broadly speaking, a given ML model of the plurality of ML models can be configured to generate, based on the sensed data comprising, for example, the 3D point cloud 312, the respective prediction for the given surrounding object in the surroundings 250 of the vehicle 220. In some non-limiting embodiments of the present technology, the respective prediction for the given surrounding object can include: (i) a location of the given surrounding object; and (ii) an object class of the given surrounding object including a respective number of features that a given ML model of the plurality of ML models is configured to determine.

More specifically, in the example of FIG. 5, based on the 3D point cloud 312, for the given surrounding object, the first ML model 502 is configured to generate a first prediction 503 for the given surrounding object; the second ML model 504 is configured to generate a second prediction 505; the third ML model 506 is configured to generate a third prediction; and the final ML model 508 is configured to generate a final prediction 509.

Further, in some non-limiting embodiments of the present technology, for causing generation of the respective prediction for the given surrounding object, along with the 3D point cloud 312, the server 235 can be configured to further feed to the given ML model of the plurality of ML models an output, that is, the respective prediction, generated by a sequentially preceding ML model. In other words, by doing so, the server 235 can be configured to define a cascade-like architecture of the MLA 260 where an output of the given ML model is used as an input to the sequentially following ML model. More specifically, in these embodiments, to cause generation of the second prediction 505, the server 235 can be configured to feed, to the second ML model 504: (i) the 3D point cloud 312; and (ii) the first prediction 503 generated by the first ML model 502. Further, to cause generation of the third prediction 507, the server 235 can be configured to feed, to the third ML model 506: (i) the 3D point cloud 312; and (ii) the second prediction 505 generated by the second ML model 504. Finally, to cause generation of the final prediction 509, the server 235 can be configured to feed, to the final ML model 508: (i) the 3D point cloud 312; and (ii) a next-to-final prediction 511 generated by an ML model sequentially preceding to the final ML model 508.

Further, in accordance with certain non-limiting embodiments of the present technology, the given ML model of the plurality of ML model of the architecture of the MLA 260 can be configured to generate the respective prediction for the given surrounding object with higher object detection precision than any preceding ML model in the plurality of ML models.

It is not limited how the object detection precision of each one of the first, second, third, and final predictions 503, 505, 507, and 509 can be defined. In some non-limiting embodiments of the present technology, the object detection precision, for each one of the first, second, third, and final ML models 502, 504, 506, and 508, can be determined as being a respective value of an object detection precision metric thereof. In various non-limiting embodiments of the present technology, the object detection precision metric can include at least one of an Average Precision object detection precision metric, an Intersection over Union object detection precision metric, a Mean Average Precision object detection precision metric, and Precision and Recall object detection precision metrics, as an example.

Thus, according to certain non-limiting embodiments of the present technology, the respective value of the object detection precision metric associated with the given ML model is indicative of a number of object features of the given surrounding object that the given ML model can be configured to determine as part of the respective prediction.

Returning to the example of FIG. 4, the first prediction 503 for the upcoming vehicle 420, generated by the first prediction model 502, can include a first set of object features, including, for example: (1) an object type of the upcoming vehicle 420, such as a movable object; (2) overall dimensions of the upcoming vehicle 420; and (3) the distance 408 to the upcoming vehicle 420. The second prediction 505, generated by the second ML model 504, can include a second set of object features, which, alternatively or in addition to the first set of object features, can include: (4) a type of the movable object, such as a vehicle; and (5) a direction of movement, such as the straight direction 406. Further, the third prediction 507, generated by the third ML model 506, can include a third set of object features, which, alternatively or in addition to the second set of object features, can further include: (6) a current speed of the upcoming vehicle 420 in the straight direction 406. Finally, the final prediction 509, generated by the final ML model 508, can include a final set of object features, which, alternatively or in addition to the previous sets of object features, can further include: (7) a body type of the upcoming vehicle 420, such as a sedan; (8) a brand of the upcoming vehicle 420; (9) a predicted traffic rule abidance score associated with the upcoming vehicle 420; and the like.

To sum up, according to certain non-limiting embodiments of the present technology, the higher the respective value of the object detection metric for the given ML model is, the higher the number of the object features of the given surrounding object the given ML model can be configured to determine. In other words, the given ML model of the plurality of ML model can be configured to determine more object features of the given surrounding object than any other ML model in the plurality of ML models preceding the given ML model. By doing so, the given ML model can be configured to provide a more detailed object detection of the given surrounding object and hence higher object detection precision than any other preceding ML model.

Further, as the given ML model can be configured to generate the respective prediction having fewer object features and/or details about the given surrounding object than any sequentially following ML models of the plurality of ML models, certain non-limiting embodiments of the present technology are based on a premise that, for generating the respective prediction, the given ML model may require less computational resources of the processor 110 of the electronic device 210 and/or of the server 235 and therefore less time than any sequentially following ML models. In other words, the time spent on generating the respective prediction by the given ML model can be said to be indicative of available computational resources of the processor 110 of the electronic device 210 and/or the server 235.

Thus, according to certain non-limiting embodiments of the present technology, in order to detect the given surrounding object for motion planning of the vehicle 220, such as generating the movement trajectory thereof, as mentioned above, the processor 110 can be configured to: (i) assign, to each one of the plurality of ML models a respective predetermined time period threshold for generating their respective predictions; (ii) sequentially cause each one of the plurality of ML models to generate their respective predictions such that: (iii) in response to the time spent on generating the respective prediction by the given ML model being lower than or equal to the respective predetermined time period threshold, the processor 110 is configured to cause the sequentially following ML model in the plurality of ML models to generate the respective prediction; and (iv) in response to the time spent on generating the respective prediction by the given ML model being greater than the respective predetermined time period threshold, the processor 110 is configured to cause motion planning of the vehicle 220 based on the respective prediction generated by the given ML model.

The developers of the present technology have appreciated that such an approach to the object detection may help use the computational resources of the electronic device 210 and/or the server 235 more effectively allowing motion planning of the vehicle 220 within an expected timeframe with less dependence on a current amount of the available computational resources.

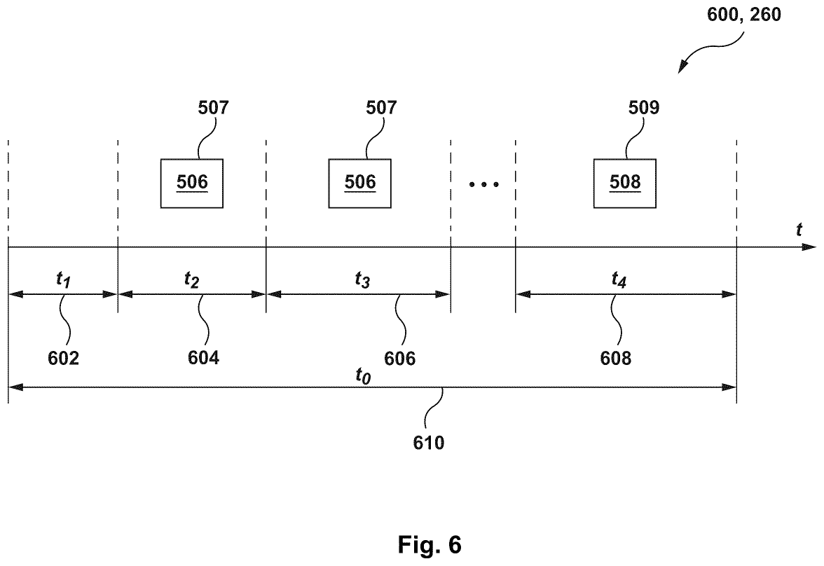

With reference to FIG. 6, there is schematically depicted a time diagram 600 of each one of the plurality of ML models generating the respective predictions for the given surrounding object, in accordance with certain non-limiting embodiments of the present technology.

More specifically, the processor 110 can be configured to assign: (i) to the first ML model 502, a first predetermined time period threshold 602 for generating the first prediction 503; (ii) to the second ML model 504, a second predetermined time period threshold 604 for generating the second prediction 505; (iii) to the third ML model 506, a third predetermined time period threshold 606 for generating the third prediction 507; and (iv) to the final ML model 508, a final predetermined time period threshold 608 for generating the final prediction 509.

Thus, if the first ML model 502 was able to generate the first prediction 503 within the first predetermined time period threshold 602, the processor 110 can be configured to cause the second ML model 504 to generate the second prediction 505. Further, if the second ML model 504 was able to generate the second prediction 505 within the second predetermined time period threshold 604, the processor 110 can be configured to cause the third ML model 506 to generate the third prediction 507. However, if the third ML model 506 failed to generate the third prediction 507 within the third predetermined time period threshold 606, which is indicative of that the processor 110 experienced a shortage of computational resources, the processor 110 can be configured to: (i) stop causing the sequentially following ML models of the plurality of ML models to generate their respective predictions; and, for example, (ii) generate the movement trajectory for the vehicle 220 based on the third prediction 507 for the given surrounding object.

In some non-limiting embodiments of the present technology, in response to determining that the time for generating the third prediction 507 has exceeded the third predetermined time period threshold 606, the processor 110 can be configured to: (i) abort causing the third ML model 506 to generate the third prediction 507; and (ii) generate the movement trajectory for the vehicle 220 based on the sequentially preceding prediction for the given surrounding object, that is, the second prediction 507.

In some non-limiting embodiments of the present technology, a given one of the first, second, third, and final predetermined time period thresholds 602, 604, 606, and 608 can be selected to be longer than a preceding one of the second, third, and final predetermined time period thresholds 604, 606, and 608. However, in other non-limiting embodiments of the present technology, each one of the first, second, third, and final predetermined time period thresholds 602, 604, 606, and 608 can have an equal duration, and comprise, for example, 5, 10, 15, or 20 milliseconds. Further, in some non-limiting embodiments of the present technology, a duration for each one of the of the first, second, third, and final predetermined time period thresholds 602, 604, 606, and 608 can be determined based on a sum thereof, which may correspond to a time limit 610 for generating the respective prediction for the given surrounding object. In some non-limiting embodiments of the present technology, the time limit 610 can be pre-determined empirically, inter alia, based on a maximum response time of the vehicle 220 to the processor 110 triggering control over the vehicle 220 according to the generated movement trajectory.

In some non-limiting embodiments of the present technology, the given ML model of the MLA 260 can be based on a neural network. In some non-limiting embodiments of the present technology, the neural network can comprise a convolutional neural network (CNN). In a specific non-limiting example, the CNN can be based on a PointNet architecture described, for example, in an article “PointNet: Deep Learning on Point Sets for 3D Classification and Segmentation,” authored by Qi et al. and published by Stanford University on Apr. 10, 2017, the content of which is incorporated herein by reference in its entirety.

In another example, the CNN used for implementing the given ML model of the MLA 260 can be based on a LaserNet architecture described, for example, in an article “LaserNet: An Efficient Probabilistic 3D Object Detector for Autonomous Driving,” authored by Meyer et al. and published by Uber Advanced Technologies Group on Mar. 20, 2019, the content of which is incorporated herein by reference in its entirety.

In yet another example, the CNN can be implemented as described in a co-owned US Patent Application Publication No.: 2022/0309,794-A1, published on Sep. 29, 2022, and entitled “METHODS AND ELECTRONIC DEVICES FOR DETECTING OBJECTS IN SURROUNDINGS OF A SELF-DRIVING CAR,” the content of which is incorporated herein by reference in its entirety.

Other example of the CNN can include, without limitation, a residual neural network (ResNet), a CenterPoint-based CNN, a U-Net-based CNN. It should be expressly understood that use of other examples of the neural network that can be configured for classifying and localizing objects in the surrounding 250 of the vehicle 220 are also envisioned without departing from the scope of the present technology.

In some non-limiting embodiments of the present technology, each one of the plurality of ML model can be of the same implementation. More specifically, each one of the first, second, third, and final ML models 502, 504, 506, and 508 can be implemented based on the same neural network architecture, such as the PointNet architecture. In other non-limiting embodiments of the present technology, each one of the plurality of ML models forming the MLA 260 can have different implementations. For example, the first ML model 502 can be a neural network based on the PointNet architecture; whereas the second ML model 504 can be a neural network based on the LaserNet architecture

Further, as mentioned hereinabove, the respective value of the object detection precision metric associated with the given ML model can be greater than that of any other ML model preceding the given ML model in the plurality of ML models of the MLA 260. In other words, each given ML model can be configured to generate the respective prediction of higher object detection precision than any preceding ML model. Certain non-limiting embodiments of the present technology are based on a premise that this can be attained, at least in part, by difference in structure among each one of the plurality of ML models.

More specifically, in the embodiments where each one of the first and second ML models 502, 504 are implemented as CNNs, the second ML model 504 can include more layers than the first ML model 502. In both cases, the second ML model 504 is thus believed to provide higher precision predictions than the first ML model 502.

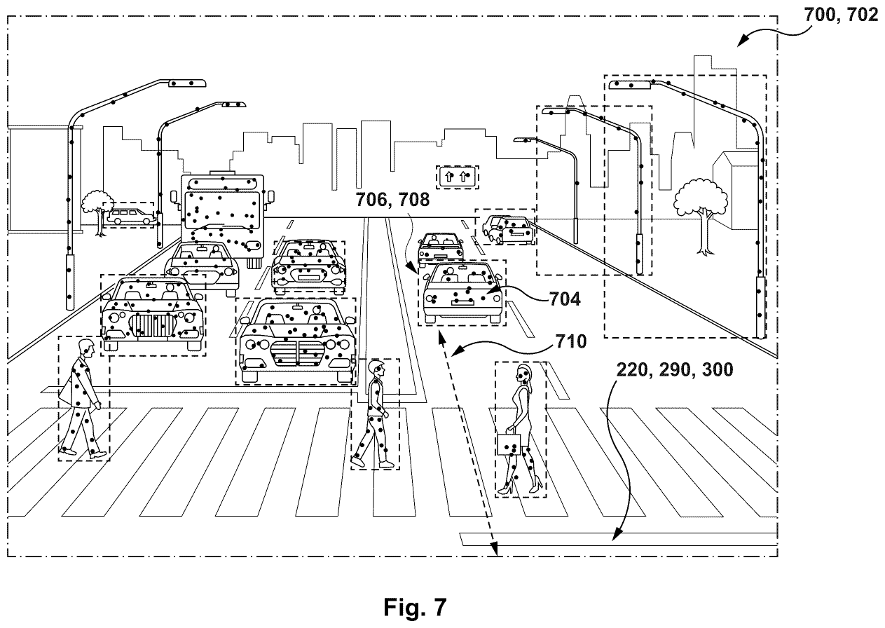

Further, generally speaking, the processor of the server 235 and/or the electronic device 210 can be said to be executing two respective processes in respect of the MLA 260. A first process of the two processes is a training process, where the processor 110, for example, of the server 235 is configured to train each one of the plurality of ML models of the MLA 260, based on the plurality of training digital objects (also referred to herein as a “training set of data”), to generate, based on sensed data, such as the 3D point cloud 312 of the given road section 402, the respective predictions of the given surrounding object, such as the upcoming vehicle 420 in the example of FIG. 4. The training process will be described in detail below with reference to FIG. 7.

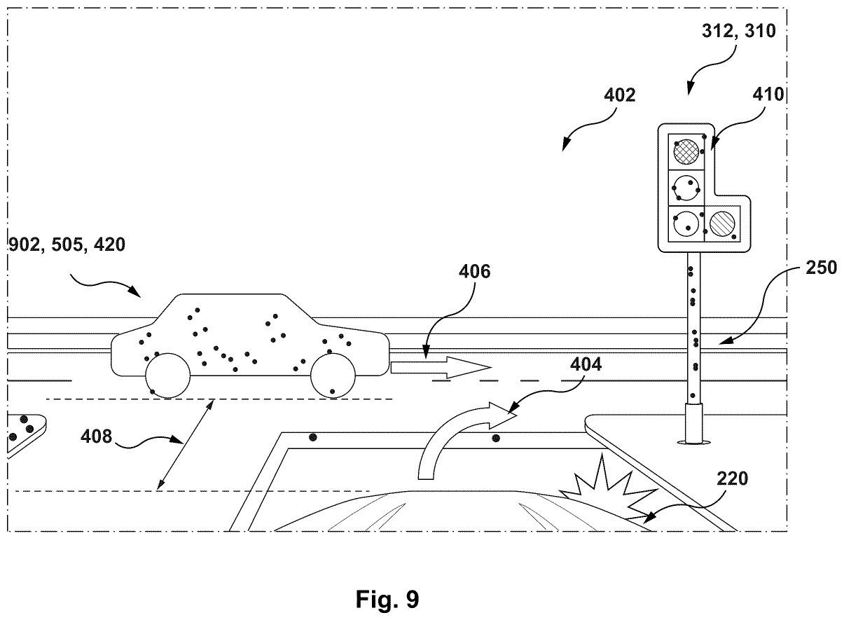

A second process is an in-use process, where the processor 110, for example, of the electronic device 210, executes the so-trained MLA 260 for determining, based on the 3D point cloud 312, the respective prediction for the upcoming vehicle 420 including its object features. The in-use process will be described in detail below with reference to FIGS. 9 to 11.

According to the non-limiting embodiments of the present technology, both the training process and the in-use process may be executed by the server 235 and/or the processor 110 of the electronic device 210 in the networked computing environment 200 described hereinabove.

### Training Process

As mentioned above, the given ML model of the MLA 260 can be trained based on the plurality of training digital objects. According to certain non-limiting embodiments of the present technology, the given training digital object includes: (i) a respective training feature vector including features representative of a given portion of the surroundings 250 of the vehicle 220; and (ii) a respective label indicative of the location and object class of at least one training object captured in the given portion of the surroundings 250.

With reference to FIG. 7, there is depicted a schematic diagram of a given representation 700 of a training road section 702 used for generating the given training digital object for training the given ML model of the MLA 260, in accordance with certain non-limiting embodiments of the present technology.

In some non-limiting embodiments of the present technology, the given training representation 700 can be generated based on data sensed by the LiDAR sensor 300 and comprise a training 3D point cloud (not separately labelled) representative of the training road section 702. Needless to mention, the training 3D point cloud can be generated similarly to the 3D point cloud 312 representative of the given road section 402, that is, by the processor 110 executing the LiDAR data acquisition procedure 302 described in detail above with reference to FIG. 3.

In other non-limiting embodiments of the present technology, the given training representation 700 can be generated based on data sensed by the camera sensor 290 and hence comprise a training image (not separately labelled) representative of the training road section 702.

In yet other non-limiting embodiments of the present technology, the given training representation 700 can be generated based on data sensed by both the LiDAR sensor 300 and the camera sensor 290 and hence comprise a merged representation (not separately labelled) of the training road section 702, including the training 3D point cloud that is merged with the training image. According to certain non-limiting embodiments of the present technology, to generate the merged representation of the training road section, the training image needs to be generated by the camera sensor 290 at a same time as the training 3D point cloud. To that end, prior to generating the merged representation, the processor 110 can be configured to synchronize operation of the camera sensor 290 and the LiDAR sensor 300 such that both the camera sensor 290 and the LiDAR sensor 300 are configured to generate their data representative of the given portion of the surroundings 250 of the vehicle 220, such as the training road section 702, at a same moment in time.

How the processor 110 can be configured to synchronize the camera sensor 290 and the LiDAR sensor 300 is not limited and may include, in some non-limiting embodiments of the present technology, determining a temporal offset between generating images by the camera sensor 290 and 3D point cloud data by the LiDAR sensor 300 in a common time referential as described in detail in a co-owned United States Patent Application Publication No.: 2021/190,923-A1 published on Jun. 24, 2021, and entitled “METHODS AND SYSTEMS FOR ONLINE SYNCHRONIZATION OF SENSORS OF SELF-DRIVING VEHICLES (SDV)”, content of which is incorporated herein by reference in its entirety.

Further, according to certain non-limiting embodiments of the present technology, the respective training feature vector for the training road section 702 can include a plurality of LiDAR features associated with LiDAR points of the training 3D point cloud representative of the training road section 702. According to certain non-limiting embodiments of the present technology, the plurality of LiDAR features can include, without limitation, (i) a total number of LiDAR points of the training point cloud; and (ii) light intensity values of each LiDAR point of the training 3D point cloud. However, it should be noted that the above LiDAR features are non-exhaustive, and in some non-limiting embodiments of the present technology, the plurality of LiDAR features of the training 3D point cloud may include other LiDAR features, such as a colour of a surface portion of the training road section 702 from which each LiDAR point has reflected; a distance, from the LiDAR sensor 300, to each LiDAR point of the training 3D point cloud, and the like.

Further, in some non-limiting embodiments of the present technology, the respective label for a given training surrounding object 704 in the training road section 702 can comprise: (i) a respective bounding box 706 defined around the given training surrounding object 704; and (ii) object features associated with the given training surrounding object 704. As mentioned hereinabove, the object features of the given training surrounding object 704 generally depend on a type thereof; and in the present example where the given training surrounding object 704 is a vehicle, the object features can include, without limitation: (i) the object type, such as a movable object; (ii) the type of the movable object, such as an inanimate object; (iii) the type of the inanimate movable object, such as a vehicle; (iv) a brand and a model of the upcoming vehicle 420; (v) an issue year of the upcoming vehicle 420; (vi) a body type of the upcoming vehicle 420, such as a sedan, a hatchback, a wagon vehicle, a minivan and others; (vii) a control type of the upcoming vehicle 420, such as traditional (operated by a driver) or driverless (that is, an other SDC); (viii) a current speed of the upcoming vehicle 420 in the straight direction 406; (ix) a distance 408 from the vehicle 220 to the upcoming vehicle 420; and others.

In another example, the object features of an other training surrounding object being a streetlamp (not separately labelled) can include, without limitation: (i) the object type, such as a stationary object; (ii) the type of the stationary object, such as a piece of light equipment; (iii) a type of the light equipment, such as a streetlamp; (iv) dimensions of the streetlamp; (v) a distance to the streetlamp; and others.

It is not limited how the server 235 can be configured to obtain the labels for each training digital object of the plurality of training digital objects. For example, in some non-limiting embodiments of the present technology, the server 235 can be configured to transmit the given training representation 700 of the training road section 702 for labelling, for example, to a server (not depicted) of an online crowdsourcing platform (such as an Amazon™ Mechanical Turk™ online crowdsourcing platform, a Yandex™ Toloka™ online crowdsourcing platform, and the like) with a respective labelling task. For example, the respective labelling task can comprise: (i) to identify, around each training surrounding object in the training road section 702, a respective bounding box, such as the respective bounding box 706 around the given training surrounding object 704; and (ii) determine at least some of the object features of the given training surrounding object 704 non-exhaustively listed above. In response, the server of the online crowdsourcing platform can be configured to transmit the given training representation 700 along with the respective labelling task to one of a plurality of human assessors whose electronic devices are communicatively coupled to the server of the online crowdsourcing platform. Once the human assessor has completed the respective labelling task, the server of the online crowdsourcing platform can be configured to transmit the so labelled given training representation 700 back to the server 235 for use in training the plurality of ML models of the MLA 260. Needless to mention, the server 235 can be configured to submit, to the server of the online crowdsourcing platform, a plurality of training representations, of other portions of the surroundings 250, for labelling. Further, based on the so labelled training representations, the server 235 can be configured to generate other training digital objects of the plurality of training digital objects.

Thus, based on the respective label associated with the given training surrounding object 704, the server 235 can be configured to determine: (i) the respective location of the given training surrounding object 704 in the coordinate system of the vehicle 220; and (ii) the object class of the given training surrounding object 704 including its object features.

Further, in some non-limiting embodiments of the present technology, based on the respective bounding box 706 obtained as part of the respective label for the given surrounding object 704, the server 235 can be configured to determine additional training features for the respective training feature vector of the given training digital object. More specifically, in these embodiments, these additional training features can be representative of coverage statistics of the training surrounding objects in the training road section 702 with LiDAR points. According to certain non-limiting embodiments of the present technology, the server 235 can be configured to determine these additional training features for the given training surrounding object 704 based on LiDAR points encompassed within the respective bounding box 706, that is, a set of LiDAR points 708.

According to certain non-limiting embodiments of the present technology, the additional training features for the given training surrounding object 704 can include, without limitation, at least one of:
a respective distance value form the vehicle 220 to the given training surrounding object 704, such as a respective distance value 710;
a surface area of the respective bounding box 706 associated with the given training surrounding object 704;
dimensions of the respective bounding box 706
a number of LiDAR points of the training 3D point cloud 604 having fallen within the respective bounding box 706—namely, a number of LiDAR points in the set of LiDAR points 708 associated contained therein;
a density of the LiDAR points in the set of LiDAR points 708;
light intensity values of the LiDAR in the set of LiDAR points 708; and
average distance values from each of the LiDAR points in the set of LiDAR points 708.

It should be expressly understood that use of other features of the training 3D point cloud and/or of the training image representative of the training road section 702, and the given training surrounding object 704, in particular (such as a current speed thereof, for example), for training the given ML model to detect the objects in the surroundings 250 of the vehicle 220 are also envisioned without departing from the scope of the present technology.

Thus, according to certain non-limiting embodiments of the present technology, the server 235 can be configured to generate the given training digital object of the plurality of training digital objects for training the given ML model of the MLA 260. Similarly, the server 235 can be configured to generate other ones of the plurality of training digital objects by processing the sensed data, generated by at least one of the camera sensor 290 and the LiDAR sensor 300, representative of other training road sections as described above, and assigning respective labels thereto. By doing so, the processor 110 can be configured to generated thousands or even hundreds of thousands of training digital objects of the plurality of training digital objects for training the MLA 260.

Further, the server 235 can be configured to feed each one of the plurality of training digital objects to the given ML model. More specifically, in the embodiments where the given ML model is implemented as a neural network described above, the server 235 can be configured to: (i) feed each one of the plurality of training digital objects to the neural network; and (ii) by minimizing a difference between a current prediction of the neural network, generated based on the given training digital object, and the respective label thereof, using, for example, a backpropagation algorithm, determine weights of each node of the neural network. In some non-limiting embodiments of the present technology, the difference between the current prediction and the respective label can be defined by a loss function. Examples of the loss function that can be used for the training of the given ML model of the MLA 260 include, without limitation, a Mean Squared Error Loss function, a Huber Loss function, a Hinge Loss function, and others.

Thus, in some non-limiting embodiments of the present technology, the server 235 can be configured to optimize the loss function while training the given ML model until the desired respective value of the object detection precision metric therefor is attained. As the respective value of the object detection precision metric associated with the given ML model, such as the first ML model 502, can be lower than that associated with the sequentially following one, such as the second ML model 504, in some non-limiting embodiments of the present technology, the server 235 can be configured to use fewer training digital objects of the plurality of training digital objects for training the first ML model 502 than for training the second ML model 504, and so on.

In some non-limiting embodiments of the present technology, the server 235 can be configured to train each one of the plurality of ML models of the MLA 260 not only based on the plurality of training digital objects, but also using an output of the sequentially preceding ML model. Put it another way, similarly to how it was described hereinabove with reference to FIG. 5, the server 235 can be configured to feed to the given ML model, along with the plurality of training digital objects, a respective training prediction of the sequentially preceding ML model.

More specifically, according to certain non-limiting embodiments of the present technology, the server 235 can be configured to feed: (i) to the first ML model 502, the plurality of training digital objects; (ii) to the second ML model 504, the plurality of training digital objects and the respective training prediction of the first ML model 502; (iii) to the third ML model 506, the plurality of training digital objects and the respective training prediction of the second ML model 504; and (iv) to the final ML model 508, the plurality of training digital objects and the respective training prediction of the next-to-final ML model (not depicted).

In some non-limiting embodiments of the present technology, the server 235 can be configured to complete the training of the given ML model first prior to using the respective training prediction thereof for training the sequentially following ML model of the plurality of ML models. In these embodiments, similarly, the server 235 can be configured to optimize respective values of the loss function, indicative of the difference between the respective training predictions and the respective labels, for each one of the plurality of ML models, sequentially.

However, in other non-limiting embodiments of the present technology, the server 235 can be configured to apply an “end-to-end” approach to the training of the plurality of ML models. More specifically, in these embodiments, the server 235 can be configured to jointly train each one of the plurality of ML models by feeding, to the given ML model, at a given training iteration: (i) a respective training digital object; and (ii) a respective value of the respective training prediction of the sequentially preceding ML model generated at the given training iteration. In these embodiments, as it may become apparent, the server 235 can be configured to optimize the respective values of the loss function, for each one of the plurality of ML models, simultaneously.

Once the server 235 has trained each one of the plurality of ML models of the MLA 260, such as the first, second, third, and final ML models 502, 504, 506, and 508, the processor 110 of one of the server 235 and the electronic device 210 can be configured to use them for generating respective predictions for the surrounding objects of the vehicle 220, as will be described immediately below.

### In-use Process

According to certain non-limiting embodiments of the present technology, to detect the surrounding objects of the vehicle 220, such as those in the given road section 402 depicted in FIG. 4, using the MLA 260 as described above, the processor 110 can be configured to: (i) receive, from the plurality of sensor systems 280 of the vehicle 220, the sensed data representative of the given road section 402, such as at least one of a respective image (not separately labelled) from the camera sensor 290 and the 3D point cloud 312 from the LiDAR sensor 300; (ii) generate, based on the sensed data of the given road section 402, a respective in-use feature vector; and (iii) feed the respective in-use feature vector to each one of the plurality of ML models.

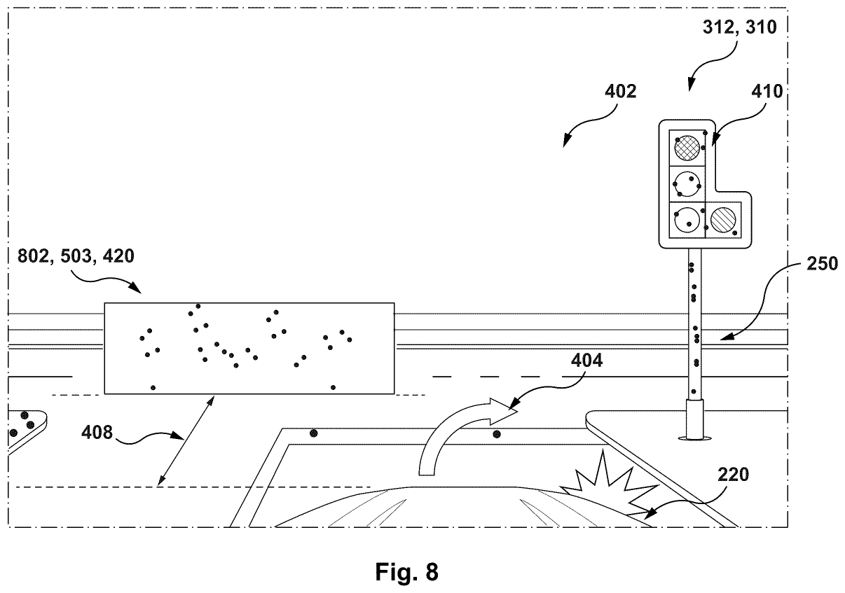

More specifically, with back reference to FIGS. 5 and 6, the processor 110 can be configured to feed, to the first ML model 502, the respective in-use feature vector representative of the given road section 402, thereby causing the first ML model 502 to generate the first prediction 503 for the given surrounding object, such as the upcoming vehicle 420. As mentioned above, the first prediction 503 can be a rough prediction, including few object features of the upcoming vehicle 420. For example, the object features determined in the first prediction 503 can include: (1) the object type, that is, a movable object; (2) the overall dimension thereof (represented, for example, by a bounding box); and (3) the distance 408 to the vehicle 220. In other words, using the first ML model 502, the processor 110 can be configured to detect a first-approximation representation 802 of the upcoming vehicle 420 schematically depicted in FIG. 8, in accordance with certain non-limiting embodiments of the present technology.

Further, if the time for generating the first prediction 503 exceeded the first predetermined time period threshold 602, which is indicative of the shortage of computational resources of the processor 110, the processor 110 can be configured to plan the motion of the vehicle 220, such as by generating the movement trajectory thereof, based on the first prediction 503.

However, if the first ML model 502 generated the first prediction 503 within the first predetermined time period threshold 602, which is indicative of a sufficient amount of available computational resources for generating more precise predictions for the upcoming vehicle 420, the processor 110 can be configured to cause the second ML model 504 to generate the second prediction 505 for the upcoming vehicle 420. To do so, in some non-limiting embodiments of the present technology, the processor 110 can be configured to feed, to the second ML model 504: (i) the respective in-use feature vector; and (ii) the first prediction 503. Alternatively or in addition to the object features of the first prediction 503, the second prediction 505 can include more detailed object features of the upcoming vehicle 420, such as: (1) the type of the movable object, that is, a vehicle; and (2) the movement direction of the upcoming vehicle 420, that is, the straight direction 406; and others. Thus, for example, the processor 110 can be configured to detect a second-approximation representation 902 of the upcoming vehicle 420, which is schematically depicted in FIG. 9, in accordance with certain non-limiting embodiments of the present technology.

Further, if the time for generating the second prediction 505 exceeded the second predetermined time period threshold 604, the processor 110 can be configured to generate the plan the motion of the vehicle 220 based on the second prediction 505.

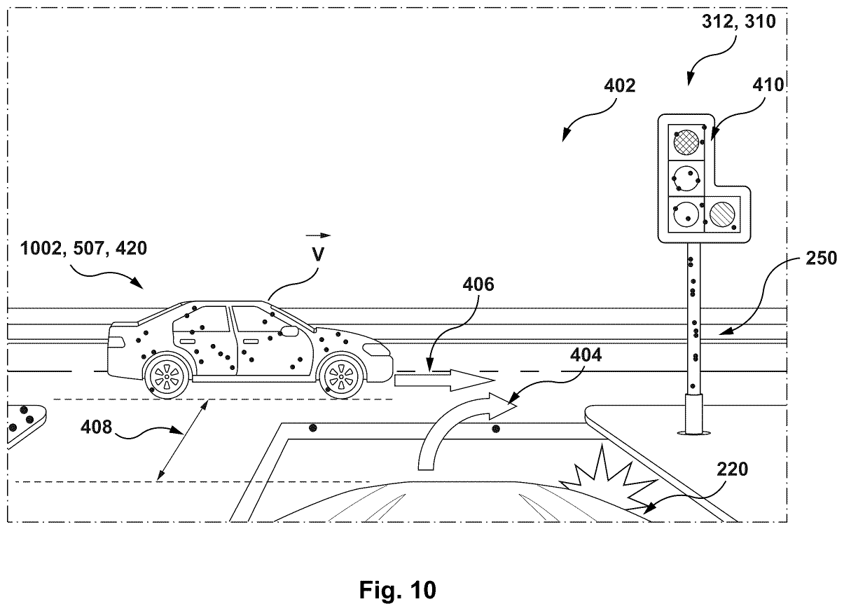

However, if the second ML model 504 generated the second prediction 505 within the second predetermined time period threshold 602, which is indicative of a sufficient amount of available computational resources for generating even more precise predictions for the upcoming vehicle 420, the processor 110 can be configured to cause the third ML model 506 to generate the third prediction 507 for the upcoming vehicle 420. To do so, in some non-limiting embodiments of the present technology, the processor 110 can be configured to feed, to the third ML model 506: (i) the respective in-use feature vector; and (ii) the second prediction 505. Alternatively or in addition to the object features of the first and second predictions 503, 505, the third prediction 505 can include even more detailed object features of the upcoming vehicle 420, such as: (1) the current speed of the upcoming vehicle 420 in the straight direction 406; (2) the body type of the upcoming vehicle 420, such as sedan; (3) the brand of the upcoming vehicle 420; and others. Thus, for example, the processor 110 can be configured to detect a third-approximation representation 1002 of the upcoming vehicle 420, which is schematically depicted in FIG. 10, in accordance with certain non-limiting embodiments of the present technology.

As it can be appreciated, if the time for generating the third prediction 507 exceeded the third predetermined time period threshold 606, the processor 110 can be configured to plan the motion of the vehicle 220 based on the third prediction 507. Else, similar to the generation of the second and third predictions 505, 507, the processor 110 can be configured to proceed to cause the sequentially following ML model to generate the respective prediction, including even more details of the upcoming vehicle 420, such as the predicted traffic rule abidance score of the driver of the upcoming vehicle 420, the issue year of the upcoming vehicle 420, and others.

Further, based on one of the first, second, and third predictions 503, 505, and 507 for the upcoming vehicle 420, in some non-limiting embodiments of the present technology, the processor 110 can be configured to generate the movement trajectory for the vehicle 220. For example, the processor 110 can be configured to cause the vehicle 220 to decelerate before the intersection such that it is possible for the vehicle 220 to yield the way to the upcoming vehicle 420.

Thus, the present methods and systems may allow using the computational resources of the electronic device 210 and/or those of the server 235 more effectively, allowing generating the movement trajectory for the vehicle 220 based on the current road scenario within the expected timeframe even in the lack of computational resources of the processor 110 of the electronic device 210 and/or the server 235 required for generating high-precision predictions for the surrounding objects.

### Method

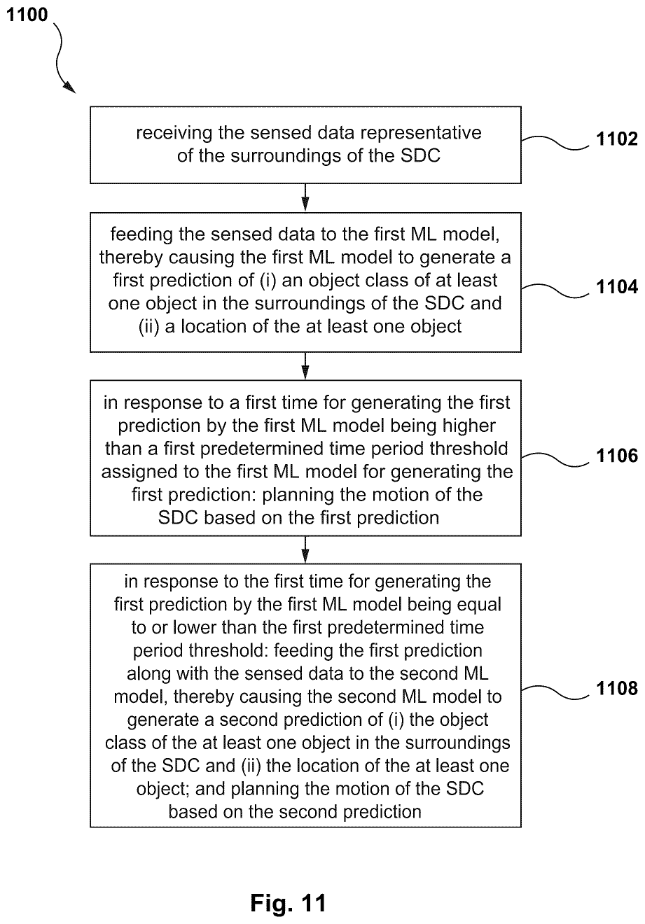

Given the architecture and the examples provided hereinabove, it is possible to execute a method for motion planning of an SDC, such as generating the movement trajectory for the vehicle 220. With reference now to FIG. 11, there is depicted a flowchart of a method 1100, according to certain non-limiting embodiments of the present technology. The method 1100 can be executed by the processor 110. The processor 110 may, for example, be part of the electronic device 210.

As mentioned hereinabove, the processor 110 can be configured to execute (or otherwise have access to) the MLA 260 trained to detect the objects in the surroundings 250 of the vehicle 220. According to certain non-limiting embodiments of the present technology, as described in detail above with reference to FIG. 5, the MLA 260 comprises the plurality of ML models sequentially connected thereamong. More specifically, the plurality of ML models is organized in such a way that the output of the given ML model, such as the first prediction 503 of the first ML model 502, is input to the sequentially following ML model of the plurality of ML models, such as the second ML model 504.

Also, according to certain non-limiting embodiments of the present technology, the given ML model of the plurality of ML models can be configured to generate the respective prediction for the given surrounding object of higher object detection precision than any other ML model preceding the given ML model in the plurality of ML models. More specifically, the respective value of the object detection precision metric associated with the given ML model can be greater than that associated with any other preceding ML models. According to certain non-limiting embodiments of the present technology, the object detection precision metric can include, without limitation, at least one of: the Average Precision object detection precision metric, the Intersection over Union object detection precision metric, the Mean Average Precision object detection precision metric, the Precision and Recall object detection precision metrics, as an example.

As mentioned further above, according to certain non-limiting embodiments of the present technology, the greater value of the object detection precision metric associated with the given ML model is indicative of the higher number of object features of the given surrounding object that the given ML model is configured to determine as part of its respective prediction than any other preceding ML models in the plurality of ML models of the MLA 260.

Thus, as mentioned further above with reference to FIG. 6, the processor 110 can be configured to assign, to each one of the plurality of ML models, the respective predetermined time period threshold for generating the respective prediction for the given surrounding object.

The processor 110 can be configured to train each one of the plurality of ML models of the MLA 260, such as the first, second, third, and final ML models 502, 504, 506, and 508 to generate the respective one of the first, second, third, and final predictions 503, 505, 507, and 509 as described in detail above with reference to FIG. 7.

### Step 1102: Receiving the Sensed Data Representative of the Surroundings of the Sdc

The method 1100 commences at step 1102 with the processor 110 being configured to receive the sensed data about the surroundings of the vehicle 220, such as the given road section 402 schematically depicted in FIG. 4. In some non-limiting embodiments of the present technology, the sensed data can comprise at least one of: (i) the respective image of the given road section 402 that the processor 110 can be configured to receive from the camera sensor 290 of the vehicle 220; and (ii) a 3D point cloud, such as the 3D point cloud 312 that the processor 110 can be configured from the LiDAR sensor 300 of the vehicle 220, by executing the LiDAR data acquisition procedure 302 described above with reference to FIG. 3.

The method 1100 hence advances to step 1104.

### Step 1104: Feeding the Sensed Data to the First ML Model, Thereby Causing the First ML Model to Generate a First Prediction of (I) an Object Class of at Least One Object in the Surroundings of the Sdc and (II) a Location of the at Least One Object

At step 1104, according to certain non-limiting embodiments of the present technology, the processor 110 can be configured to feed the sensed data to the MLA 260. More specifically, as described above with reference to FIGS. 5 and 9 to 11, first, the processor 110 can be configured to feed the sensed data to the first ML model 502, thereby causing the first model 502 to generate the first prediction 503 for the given surrounding object, such as the upcoming vehicle 420 in the given road section 402, including the location and the object class of the upcoming vehicle 420.

As mentioned hereinabove, the object class include the plurality of features of the given surrounding object. Thus, the first prediction 503 can be a rough prediction of the upcoming vehicle 420, that is, including few object features thereof, enabling the processor 110 to detect the first-approximation representation 802 of the upcoming vehicle 420, which is schematically depicted in FIG. 8.

The method 1100 thus proceeds to step 1106.

### Step 1106: In Response to a First Time for Generating the First

Prediction by the First ML Model being Higher than a First

### Predetermined Time Period Threshold Assigned to the First Ml

### Model for Generating the First Prediction: Planning the Motion

### Of the SDC Based on the First Prediction

At step 1106, according to certain non-limiting embodiments of the present technology, in response to determining that the time for generating the first prediction 503 exceeded the first predetermined time period threshold 602 assigned to the first ML model 502, which is indicative of the shortage of the computational resources of the processor 110, according to certain non-limiting embodiments of the present technology, the processor 110 can be configured to generate the movement trajectory for the vehicle 220 based on the first prediction 503.

In other words, if the time for generating the first prediction 503 exceeded the first predetermined time period threshold 602, the processor 110 can be configured not to use the sequentially following ML models for generating more precise predictions for the given surrounding object, and use the first prediction 503 for generating the movement trajectory for the vehicle 220.

The method 1100 hence advances to step 1108.

Step 1108: In Response to the First Time for Generating the First Prediction by the First ML Model being Equal to or Lower than The First Predetermined Time Period Threshold: Feeding the First Prediction Along with the Sensed Data to the Second ML Model, Thereby Causing the Second ML Model to Generate a Second Prediction of (I) the Object Class of the at Least One Object in the Surroundings of the SDC and (II) the Location of the at Least One Object; and Planning the Motion of the SDC Based on the Second Prediction

At step 1108, in response to determining that the first ML model 502 was able to generate the first prediction 503 within the first predetermined time period threshold 602, which is indicative of the sufficient amount of computational resources for generating a more precise prediction, the processor 110 can be configured to feed (i) the sensed data; and (ii) the first prediction 503 to the sequentially following ML model, that is, the second ML model 504. By doing so, the processor 110 causes the second ML model 504 to generate the second prediction 505, which can include more object detection features of the upcoming vehicle 420 than those determined by the first ML model 502 in the first prediction 503. Based on these features, the processor 110 can be configured to detect the second-approximation representation 902 of the upcoming vehicle 420 schematically depicted in FIG. 9. As it can be appreciated, the second-approximation representation 902 is a more precise representation of the upcoming vehicle 420 than the first-approximation representation 802.

Further, if the time for generating the second prediction 505 exceeded the second predetermined time period threshold 604, the processor 110 can be configured to generate the movement trajectory for the vehicle 220 based on the second prediction. Else, in a similar fashion, the processor 110 can be configured to cause the third ML model 506 to generate the third prediction 507 for the upcoming vehicle 420, which is more precise (that is, including more object features thereof) than the second prediction 505.

Thus, the processor 110 can be configured to continue causing the sequentially following ML models to generate more precise predictions for the upcoming vehicle 420 until the respective time for generating one of these predictions exceeds the respective predetermined time period threshold associated with the respective ML model in the plurality of ML models.

Further, based on one of the respective predictions, that is, the most precise one given the currently available computational resources of the processor 110, in some non-limiting embodiments of the present technology, the processor 110 can be configured to generate the movement trajectory for the vehicle 220. In the example of FIG. 4, the processor 110 can be configured to cause the vehicle 220 to decelerate before the intersection such that it is possible for the vehicle 220 to yield the way to the upcoming vehicle 420, prior to performing the right maneuver 404.

As mentioned hereinabove, although most of the examples provided above illustrate using the method 110 the motion planning of the vehicle 220 being the generating the movement trajectory thereof, other broader non-limiting embodiments of the method 1100 can be used, mutatis mutandis, for determining certain motion parameters of the vehicle 220 at the given future moment in time. These motion parameters can include, without limitation, at least one of: the displacement, the velocity, and the acceleration of the vehicle 220 at the given future moment in time.

The method 1100 hence terminates.

Modifications and improvements to the above-described implementations of the present technology may become apparent to those skilled in the art. The foregoing description includes example implementations of the present technology an in no way intends to be limiting. The scope of the present technology is therefore intended to be limited solely by the scope of the appended claims.

While the above-described implementations have been described and shown with reference to particular steps performed in a particular order, it will be understood that some of these steps may be combined, sub-divided, or re-ordered without departing from the teachings of the present technology. Accordingly, the order and grouping of the steps is not a limitation of the present technology.

1. A computer-implemented method for planning motion of a Self-Driving Car (SDC), the SDC having a plurality of sensors configured to generate sensed data representative of surroundings of the SDC, the SDC being communicatively coupled to a processor configured to execute a plurality of Machine-Learning (ML) models for detecting objects in the surroundings of the SDC, the plurality of ML models being sequentially connected therebetween, such that an output of a first ML model of the plurality of ML models is used as an input to a second ML model, sequentially following after the first ML model in the plurality of ML models,
each one of the plurality of ML models having been trained to detect the objects in the surroundings of the SDC based on the sensed data representative thereof;
a given sequential ML model being configured to detect the objects with a respective value of an object detection precision metric,
the respective value of the object detection precision metric associated with the given sequential ML model being higher than any one of those that are associated with ML models of the plurality of ML models preceding the given sequential ML model;
the method comprising:
receiving the sensed data representative of the surroundings of the SDC;
feeding the sensed data to the plurality of the ML models, the feeding comprising:
feeding the sensed data to the first ML model, thereby causing the first ML model to generate a first prediction of (i) an object class of at least one object in the surroundings of the SDC and (ii) a location of the at least one object; and
in response to a first time for generating the first prediction by the first ML model being higher than a first predetermined time period threshold assigned to the first ML model for generating the first prediction:
planning the motion of the SDC based on the first prediction; and
in response to the first time for generating the first prediction by the first ML model being equal to or lower than the first predetermined time period threshold:
feeding the first prediction along with the sensed data to the second ML model, thereby causing the second ML model to generate a second prediction of (i) the object class of the at least one object in the surroundings of the SDC and (ii) the location of the at least one object; and
planning the motion of the SDC based on the second prediction.

2. The method of claim 1, wherein the first time for generating the first prediction is indicative of current availability of computational resources of the processor of the SDC.

3. The method of claim 1, further comprising training each one of the plurality of ML models, by:
generating a training set of data comprising a plurality of training digital objects, a given one of which includes: (i) training sensed data representative of training surroundings of the SDC; and (ii) a respective label representative of the object class and location of at least one training object in the training surrounding of the SDC; and
feeding the training data to the plurality of ML models, the feeding comprising:
to the first ML model of the plurality of ML models, feeding the training data;
to the given sequential ML model following the first ML model, feeding, by the processor: (i) the training data and (ii) a respective training prediction generated by an ML model preceding the given sequential one; and
optimizing, for each one of the plurality of ML models, a respective difference between the respective training prediction thereof and the respective label, thereby training each one of the plurality of ML models to detect the objects on the surroundings of the SDC.

4. The method of claim 1, further comprising:
in response to the second time for generating the second prediction by the second ML model being equal to or lower than a second predetermined time period threshold assigned to the second ML model for generating the second prediction:
feeding the second prediction along with the sensed data to a third ML model of the plurality of ML models, following the second ML model, thereby causing the third ML model to generate a third prediction of (i) the object class of the at least one object in the surroundings of the SDC and (ii) the location of the at least one object; and
planning the motion of the SDC based on the third prediction.

5. The method of claim 1, further comprising:
in response to a respective time for generating a respective prediction by the given sequential ML model being equal to or lower than a respective predetermined time period threshold assigned to the given ML model for generating the respective prediction:
feeding the respective prediction along with the sensed data to a next sequential ML model of the plurality of ML models, following the given sequential ML model, thereby causing the next sequential ML model to generate an other respective prediction of (i) the object class of the at least one object in the surroundings of the SDC and (ii) the location of the at least one object; and
planning the motion of the SDC based on the respective prediction generated by the next sequential ML model; and
in response to the respective time for generating the respective prediction by the given sequential ML model being higher than the respective predetermined time period threshold assigned to the given ML model for generating the respective prediction:
planning the motion of the SDC based on the respective prediction generated by an ML model, immediately preceding the given sequential ML model.

6. The method of claim 1, wherein a given value of the object detection precision metric is indicative of a number of features of a given object determined by a respective ML model.

7. The method of claim 6, wherein the object detection precision metric is an average precision metric.

8. The method of claim 1, wherein a given one of the plurality of ML models is a neural network.

9. The method of claim 8, wherein the given sequential model of the plurality of ML models is configured to determine a larger number of features of the at least one object in the surroundings of the SDC than any ML model preceding the given sequential ML model.

10. The method of claim 9, wherein the given ML model of the plurality of ML models has more layers than any ML model preceding the given ML model.

11. The method of claim 1, wherein the planning the motion of the SDC comprises generating a trajectory for the SDC.

12. The method of claim 1, wherein the planning the motion of the SDC comprises determining motion parameters of the SDC, including at least one of: a displacement, a velocity, and an acceleration of the SDC at a given future moment in time.

13. A system for planning motion of a Self-Driving Car (SDC), the SDC having a plurality of sensors configured to generate sensed data representative of surroundings of the SDC, the system comprising at least one processor communicatively coupled to the SDC and configured to execute a plurality of Machine-Learning (ML) models for detecting objects in the surroundings of the SDC, the plurality of ML models being sequentially connected therebetween, such that an output of a first ML model of the plurality of ML models is used as an input to a second ML model, sequentially following after the first ML model in the plurality of ML models,
each one of the plurality of ML models having been trained to detect the objects in the surroundings of the SDC based on the sensed data representative thereof;
a given sequential ML model being configured to detect the objects with a respective value of an object detection precision metric,
the respective value of the object detection precision metric associated with the given sequential ML model being higher than any one of those that are associated with ML models of the plurality of ML models preceding the given sequential ML model;
the system further comprising at least one non-transitory computer-readable memory comprising executable instructions that, when executed by the at least one processor, cause the system to:
receive the sensed data representative of the surroundings of the SDC;
feed the sensed data to the plurality of the ML models, by:
feeding the sensed data to the first ML model, thereby causing the first ML model to generate a first prediction of (i) an object class of at least one object in the surroundings of the SDC and (ii) a location of the at least one object; and
in response to a first time for generating the first prediction by the first ML model being higher than a first predetermined time period threshold assigned to the first ML model for generating the first prediction:
planning the motion of the SDC based on the first prediction; and
in response to the first time for generating the first prediction by the first ML model being equal to or lower than the first predetermined time period threshold:
feeding the first prediction along with the sensed data to the second ML model, thereby causing the second ML model to generate a second prediction of (i) the object class of the at least one object in the surroundings of the SDC and (ii) the location of the at least one object; and
planning the motion of the SDC based on the second prediction.

14. The system of claim 13, wherein the first time for generating the first prediction is indicative of current availability of computational resources of the processor of the SDC.

15. The system of claim 13, wherein the at least one processor further causes the system to train each one of the plurality of ML models, by:
generating a training set of data comprising a plurality of training digital objects, a given one of which includes: (i) training sensed data representative of training surroundings of the SDC; and (ii) a respective label representative of the object class and location of at least one training object in the training surrounding of the SDC; and
feeding the training data to the plurality of ML models, the feeding comprising:
to the first ML model of the plurality of ML models, feeding the training data;
to the given sequential ML model following the first ML model, feeding, by the processor: (i) the training data and (ii) a respective training prediction generated by an ML model preceding the given sequential one; and
optimizing, for each one of the plurality of ML models, a respective difference between the respective training prediction thereof and the respective label, thereby training each one of the plurality of ML models to detect the objects on the surroundings of the SDC.

16. The system of claim 13, wherein the at least one processor further causes the system to:
in response to the second time for generating the second prediction by the second ML model being equal to or lower than a second predetermined time period threshold assigned to the second ML model for generating the second prediction:
feed the second prediction along with the sensed data to a third ML model of the plurality of ML models, following the second ML model, thereby causing the third ML model to generate a third prediction of (i) the object class of the at least one object in the surroundings of the SDC and (ii) the location of the at least one object; and
plan the motion of the SDC based on the third prediction.

17. The system of claim 13, wherein the at least one processor further causes the system to:
in response to a respective time for generating a respective prediction by the given sequential ML model being equal to or lower than a respective predetermined time period threshold assigned to the given ML model for generating the respective prediction:
feed the respective prediction along with the sensed data to a next sequential ML model of the plurality of ML models, following the given sequential ML model, thereby causing the next sequential ML model to generate an other respective prediction of (i) the object class of the at least one object in the surroundings of the SDC and (ii) the location of the at least one object; and
plan the motion of the SDC based on the respective prediction generated by the next sequential ML model; and
in response to the respective time for generating the respective prediction by the given sequential ML model being higher than the respective predetermined time period threshold assigned to the given ML model for generating the respective prediction:
plan the motion of the SDC based on the respective prediction generated by an ML model, immediately preceding the given sequential ML model.

18. The system of claim 11, wherein a given value of the object detection precision metric is indicative of a number of features of a given object determined by a respective ML model.

19. The system of claim 18, wherein the given sequential model of the plurality of ML models is configured to determine a larger number of features of the at least one object in the surroundings of the SDC than any ML model preceding the given sequential ML model.

20. The system of claim 19, wherein the given ML model of the plurality of ML models has more layers than any ML model preceding the given ML model.
